(19) United States
(12) Patent Application Publication
(10) Pub. No.: US 2010/0174915 A1
(43) Pub. Date: Jul. 8, 2010

(54) TURNOVER CONTROLLER

(76) Inventor: Milan Prokin, Belgrade (RS)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 12/602,491

(22) PCT Filed: May 29, 2008
(86) PCT No.: PCT/RS2008/000013

§ 371 Date: Nov. 30, 2009

(30) Foreign Application Priority Data
May 30, 2007 (RS) P-2007/0237

(51) Int. Cl. G06F 17/00; G06F 12/14

(52) U.S. Cl. 713/189; 700/90

(57) ABSTRACT

This disclosure solves the problem of data security of transactions and turnovers in all distribution levels, including monitoring by the appropriate government institutions, in order to prevent tax avoidance, VAT fraud, smuggling, bootlegging, diversion of original goods from the distribution system and infiltration into the distribution system of counterfeited and original goods without payment of customs, tax and excise duties.

### CROSS-REFERENCE TO RELATED APPLICATIONS

This patent application claims priority to PCT International Patent Application No. PCT/RS2008/000013, filed May 29, 2008, and Serbia Patent Application No. P-2007/0237, filed May 30, 2007, each of which is hereby incorporated by reference herein in its entirety.

### FIELD OF THE DISCLOSURE

This disclosure relates to the field of networked fiscal cash registers and fiscal printers.

### BACKGROUND OF THE DISCLOSURE

State-of-the-art non-fiscal and fiscal cash registers are standalone, or are networked locally by wired or wireless network to a back-office server within a single retail shop or a company, in order to control one or at most two levels of distribution of goods and services.

State-of-the-art non-fiscal and fiscal printers are connected to PC or POS system, which are independent or are networked locally by wired or wireless network to a back-office server within a single retail shop or a company, in order to control one or at most two levels of distribution of goods and services.

Data security in non-fiscal cash registers and non-fiscal printers (in further text: non-fiscal registers) is minimal. However, data security in fiscal cash registers and fiscal printers (in further text: fiscal registers) is also not satisfactory, which will be presented in detail using particular examples of their misuse.

Standalone fiscal cash registers are mandatory in many countries for storing turnover of goods and services in retail and providing the appropriate reports to tax inspection.

This disclosure solves the problem of data security of transactions and turnovers through all distribution levels, including monitoring by the appropriate government institutions, in order to prevent tax evasion, VAT fraud, smuggling, bootlegging, diversion of original goods from the distribution system and infiltration into the distribution system of counterfeited and original goods without payment of customs, tax and excise duties.

U.S. Pat. No. 4,293,911 issued October 1981 to the inventor S. Oonishi describes an electronic cash register with a system for automatic generation of codes of goods and services.

Italian patent IT1129483 issued June 1986 to the inventor W. Gillone and European patent. EP 0058803 B1 issued November 1986. to inventors M. Bovio et al. describe a cash register with incremental counters, which are realized as a memory with counting cells, wherein a bit can be written and read, but it cannot be cleared.

U.S. Pat. No. 4,787,037 issued November 1988 to the inventor T. Ootsuka describes an electronic cash register which sends data about sales to an external device for printing.

U.S. Pat. No. 4,799,156 issued January 1989 to inventors E. Shavit et al. describes a system for interactive on-line electronic marketing communications and processing of business transactions using remote terminals between a plurality of sellers, buyers, financial institutions and freight service providers.

European patent EP0234402 issued January 1993 to inventors K. Munakata et al. describes an electronic cash register with a bar-code reader and a memory of goods and services with a price of a metric unit and a discounted price.

Japanese patent JP5120567 issued May 1993 to inventors Y. Uenishi et al. describes a fiscal cash register with additional microcontrollers between a main processor and a keyboard, a display and a printer, which can be inside a main enclosure or inside an enclosure of the keyboard, an enclosure of the display and an enclosure of the printer.

U.S. Pat. No. 5,222,018 issued June 1993 to inventors M. S. Sharpe et al. describes a system for determining and accounting for the costs of transactions, particularly shipping goods based on an input device which is located at the shipper's or buyer's premises and a central data processing facility.

Japanese patent JP7014073 issued January 1995 to the inventor K. Nishihara describes a fiscal cash register with a printer for a journal tape.

Polish patent PL181004 issued October 1996 to inventors H. Orlowski et al. describes various realizations of a service seal based on the application of various materials over a screw, which prevents the removal of a service seal without damage and its return later on.

Italian patent IT950489 issued December 1996 to the inventor A. Toniolo describes a fiscal cash register with a protection from opening of an enclosure using a wire serving as a current circuit breaker.

U.S. Pat. No. 5,638,519 issued June 1997 to the inventor J. E. Haluska describes tracking of business transactions via an electronic system comprising a provider computer, at least one receiver computer and a business controller in the electrical communication with the provider computer and at least one receiver computer.

U.S. Pat. No. 5,644,724 issued July 1997 to the inventor D. J. Cretzler describes a method for automatic sending of tax from the seller's computer to a computer in a seller's bank and transfers summed tax amount to a bank of the tax authority.

Russian patent RU2106015 issued February 1998 to inventors P. A. Orlov et al. describes a method of control of electronic cash registers, using a portable memory unit independent of a power supply for reading and storage of data from a fiscal memory of an electronic cash register.

U.S. Pat. No. 5,774,872 issued June 1998 to inventors R. Golden et al. describes a method for networking POS systems through a subsystem for data collection, connected to a central computer, which generates tax reports about transactions and sends them to a tax authority.

U.S. Pat. No. 5,799,283 issued August 1998 to inventors P. A. Francisco et al. describes a smart tax register, which is located at a retailer location, and which calculates the amount of sales tax during each transaction and immediately sends data about the transaction and sale to a tax authority.

Japanese patent JP11185156 issued July 1999 to the inventor T. Hirasawa describes a case body structure of an electronic cash register, which opening is prevented by a service seal.

Japanese patent JP11185157 issued July 1999 to the inventor T. Hirasawa describes means for economically changing a fiscal memory of an electronic cash register protected by a fiscal seal.

PCT patent application WO99/66465 published December 1999 with D. S. Teixeira et al. as inventors, describes a fiscal cash register with an electronic journal instead of a journal tape.

Japanese patent application JP2000207645 published July 2000 with A. Matsui et al. as inventors, describes a prevention of a program change in a program memory by exchanging data bus lines D0 and D1, as well as data bus lines D4 and D5.

PCT patent application WO00/19387 published April 2000 with A. Conde et al. as inventors, describes an electronic journal with a verification capability on a POS system, thanks to a data signature, which can be encrypted, wherein the associated public key is stored in a file with an electronic journal.

U.S. Pat. No. 6,058,375 issued May 2000 to the inventor J. Park describes an automatic processor and a method for accounting of transactions in real-time.

U.S. Pat. No. 6,199,049 issued March 2001 to inventors Conde et al. describes secure electronic journal using an encryption of a digital signature generated on the basis of transaction data.

Latvian patent LV12636 issued June 2001 to the inventor V. Rudenko describes a protection of FLASH fiscal memory from data clear and change using logic circuits, which prevent writing of more than 4 consecutive bytes with bits A8 and A9 equal to one.

PCT patent application WO01/097441 published December 2001 with W. R. Hucaby as an inventor, describes a method and a system for reducing the susceptibility of hacking a private key of a private/public key pair, based on a generation or embedding of that private key inside secure hardware inside a fiscal printer at the time of manufacture, which additionally can provide authentication of printed reports based on a data from a fiscal memory.

U.S. Pat. No. 6,360,208 issued March 2002 to inventors M. Ohanian et al. describes a machine readable code applied to sale articles, associated to a central database with information about a manufacturer of an article and information about paid tax for that article.

European patent application EP1205895 issued May 2002 with G. Scarton as an inventor, describes an integrated cash register with a GSM transmission/reception unit for transmitting the data processed by an electronic transaction unit having a card input unit, via radio waves to a remote reception unit, such as a bank.

PCT patent application WO02/065416 published August 2002 with M. Squitieri as an inventor, describes an electronic cash register with an internal processing block operating as a cash register and an external processing block operating as a cash register, which executes external commands.

Russian patents RU2237280 issued September 2004 to the inventor A. I. Gorshkov and RU2266562 issued December 2005 to the inventor A. I. Gorshkov describes a manner for a sale registration together with a manual fiscalization of fiscal cash registers using manual delivery of information about a seller, as well as individual characteristics of the communication channel from a mobile phone of a seller to a registration center. The registration center stores these data into a database, generates seller's identifiers and provides a key for database access to a seller. A fiscal cash register of a seller prints numerated checks with fixed price intervals before a sale together with information about the registration center. The seller activates these checks and sends numbers of activated checks to the registration center. In the center, activated checks are registered with seller's identifiers in the fiscal memory of the registration center.

U.S. patent application US2003/0040992 published February 2003 and European patent application EP1286291 published February 2003 with F. W. Ryan Jr. et al. as inventors, describes a device for secure tax measurement and certified provider center for data collection about sales and sales tax over the Internet, which does not provide that each printed transaction is also stored, since main program controlling printing of receipts is executed on a main computer, which can be hacked.

U.S. Pat. No. 6,556,216 issued April 2003 to inventors R. T. Cato et al. describes a method and system for controlling a system display from the processor controlling a fiscal printer, by generating an overlay image over the image generated by the application software and hardware.

PCT patent application WO03/050687 A1 published June 2003 with A. J. Mihajlovich et al. as inventors, describes an electronic cryptographic module and a method for protecting and authenticating information in a fiscal cash register by writing data and digital signatures into the fiscal memory.

U.S. patent application US2004/0255141A1 published December 2004 with L. B. Hodder et al. as inventors, describes a fiscal data recorder. A fiscal memory module utilizes a circuit for the prevention of overwriting already written memory locations. However, this circuit enables overwriting 0xFF values in the fiscal memory, since it treats such locations like empty ones. An electronic journal module utilizes a dedicated microcontroller for reading and writing operations. The physical protection covers a fiscal seal made of an epoxy compound, sealed sticker designed to be torn apart after its removal attempt from an EPROM with a program, a seal preventing unauthorized removal of the first sealing wire passing through holes with screws for attaching an electronic journal module and a seal preventing unauthorized removal of the second sealing write passing through two holes on an enclosure and attached on a visible part of a security plate. The alternative protection of an electronic journal module also utilizes an epoxy compound.

The fiscal register law published in the Official Gazette of Republic of Serbia No. 135/04 Dec. 21, 2004. and at the Internet page of Ministry of Finance of Serbia (www.mfin.sr.gov.yu) requires that each fiscal register must have a terminal for remote reading of all formed daily reports from a fiscal register in the prescribed period, while detailed technical requirements for these terminals requiring data sending over GPRS network are provided at the Internet page of the Direction for measurements and precious metals (www.szmdm.sv.gov.yu/fiskalne_kase.htm), which certificates these terminals.

U.S. Pat. No. 6,889,325 issued May 2005 to inventors W. H. M. Sipman et al. describes a data network with a secure and trusted transaction server connecting data input/output terminals of the parties.

European patent application EP1607897 published December 2005 with I. Andriopoulos as an inventor, describes a method, system and device for checking the authenticity of the source and integrity of the content of VAT transactions using unique electronic transaction codes.

Japanese patent application JP2006082315 published March 2006 with A. Tsukasa as an inventor, describes a conversion of a standard printer into a fiscal printer by inserting a fiscal card through a card slot at a front face of the body.

PCT patent application WO2006/030425A3 published March 2006 with A. Avdar as an inventor, describes a system and method for the analysis of fiscal transactions send by a company to a database in order to detect tax fraud.

Brazilian patent application PI0503091-9 published September 2006 with E. A. Gois et al. as inventors, describes a system for checking of printing by fiscal registers using a connection of a controlling device in series or in parallel with the connection between PC or POS system and the fiscal register.

Brazilian patent application PI0504611-4A published December 2006 with J. A. P. Filho as an inventor, describes an electronic system for sending fiscal information using a GPRS network. The focus is on the GPRS network as a part of the system, without any protocols or other technical details about how data are collected from fiscal cash registers and send over the GPRS network.

### SUMMARY OF THE DISCLOSURE

Typical data protection in fiscal registers is provided by the combination of mechanical and software means, as defined by an appropriate law, which comprises:

a) prevention of opening of an enclosure of a fiscal register and access to electronic parts of the fiscal register: a microcontroller, a program memory, an operating memory, a journal memory (if exists), a fiscal memory, a keyboard, a display, a printer, etc., using a service seal (usually made of a special material covering a screw, and sealed by the authorized serviceman);

b) optional protection of the program memory (usually of PROM, OTPROM or EPROM type, as well as EEPROM or FLASH type with a circuit for the prevention of the erasure of written data) from removal, change or clear using a program seal (usually a sticker with a protection);

c) storage into the operating memory (usually of SRAM type with a backup battery) of PLU (Price Look-Up) database of goods and services with codes of goods and services (usually bar-codes), names of goods and services, names of metric units and assigned tax rates;

d) storage into the operating memory of amounts of individual transactions and summary turnovers of goods and services until forming a daily report;

e) optional detection of a low power supply voltage of the operating memory using a circuit for a low power supply voltage detection and writing into the fiscal memory of date and time of that detection;

f) optional detection of a reset of the operating memory using a reset detection circuit and writing into the fiscal memory of date and time of that reset;

g) printing onto the journal tape (if exists) of data about sold goods and services from fiscal receipts, as well as date and time of forming fiscal receipts;

h) storage into the journal memory (if exists) of data about sold goods and services from fiscal receipts, as well as date and time of forming fiscal receipts;

i) optional protection of the journal memory (usually of EEPROM or FLASH type) from removal by assembling it within the enclosure of the fiscal register;

j) optional protection of the journal memory from change or clear using additional written data (usually a checksum);

k) storage into the fiscal memory (usually of PROM, OTPROM or EPROM type, as well as EEPROM or FLASH type with a circuit for the prevention of the erasure of written data) of daily reports, types of services, types of resets and tax rates, as well as date and time of forming these records;

l) protection of the fiscal memory from removal, change or clear using: coating by a hardening compound (usually epoxy resin), fiscal seal (usually a sticker with a protection) and additional written data (usually a checksum of zero bits within a data block);

m) protection from clear of counters of a serial number of a fiscal receipt, a daily report, a service, a reset and a change of tax rates;

n) protection from manual change of date and time from the moment of issuing a first fiscal receipt until forming next daily report summing turnover from that first fiscal receipt;

o) protection from manual change of date and time into date and time older than date and time of last record in the fiscal memory;

p) printing of special marks (fiscal logo) on fiscal documents (fiscal receipt, refunded receipt, X-report, daily report, periodic report, etc.) in order to be differentiated from non-fiscal documents (non-fiscal invoice, kitchen order, bar order, various reports, etc.) which might mislead buyer of goods and services; etc.

Types of protection of stickers can be:

a) visual protection marks;

b) void-label;

c) optical variable devices;

d) hologram;

e) protection marks visible under ultraviolet light;

f) protection marks visible under infrared light;

g) DNA protection seal, visible in the presence of a complementary DNA; etc.

General disadvantages of stickers are:

a) stickers can be counterfeited;

b) stickers can be bought on the black market;

c) verification procedure cannot be automatic;

d) expensive protection in case that many parts must be protected;

e) most security features cannot be verified by the client;

f) expensive additional equipment is necessary for some verifications; etc.

A blank memory of PROM, OTPROM or EPROM type comprises all ones, which are converted to zeroes during programming. Usual protection of such memory assumes a control checksum of zero bits per each data block. Since written zero cannot be converted into one without clearing memory, any change of written data reduces to writing zeros, which requires increase of a checksum, i.e. increase of a number of ones, which is impossible to be done.

In further text “unregistered” means an absence of automatically generated electronic track about some activity.

Major disadvantages of fiscal registers from the point of view of a tax administration are:

a) complicated fiscalization process (manual registration of a fiscal register) comprising assembling of empty fiscal memory, a fiscal, a program and a service seal in the presence of a tax inspector;

b) possibility to assembly a fiscal and a program seal in such manner to enable their later removal and return without any damage, in spite of the presence of a tax inspector;

c) slow process of the implementation of fiscal registers in the field because of insufficient number of authorized services wherein fiscal registers can be fiscalized, insufficient number of authorized servicemen and insufficient number of tax inspectors performing the fiscalization, as well as huge number of manual operations which should be performed during the fiscalization;

d) complicated process of training of tax inspectors for audit in the field due to complicated user manual of fiscal registers themselves;

e) inefficient audit of fiscal registers in the field from the side of tax inspectors due to time spent with each fiscal register and distance between controlled fiscal registers;

f) complicated defiscalization process (manual deregistration of a fiscal register) and removal of service, program and fiscal seals and full fiscal memory in the presence of a tax inspector;

g) storage of full fiscal memory together with a part of an enclosure of the fiscal register in the service until receiving approval for its destruction; and

h) delivery of a tax report with summed turnover of sold goods and services that is less than summed turnover of sold goods and services in the fiscal memory, i.e. “creative book-keeping”, considering insufficient number of tax inspectors in the field.

Possible errors during fiscalization of all fiscal registers are:

a) manual entering of a wrong identification number of a fiscal register; and

b) manual entering of a wrong identification number of a tax payer.

Consequences of such errors during fiscalization are:

a) difficult searching for particular fiscal register with the wrong identification number of a fiscal register;

b) difficult audit of several fiscal registers with the same identification number of a fiscal register;

c) difficult searching for particular fiscal register with the wrong identification number of a tax payer in the fiscal register; and

d) difficult audit of several fiscal registers belonging to different tax payers with the same identification number of a tax payer in the fiscal register.

Possible various misuses of tax rates on fiscal registers are:

a) unauthorized change of tax rates;

b) entering wrong tax rates;

c) delayed entering of new tax rates; and

d) advanced entering of new tax rates.

Possible various misuses of PLU base of goods and services on fiscal registers are:

a) assignment of wrong tax rates to particular PLUs;

b) non-unique or ambiguous definition of PLU names;

c) definition of wrong PLU metric unit; and

d) sale of unknown goods and services using departments, instead of PLU base.

Possible misuses of date and time on fiscal registers are:

a) changing date and time into wrong date and time, which leads to a confusion during audit; and

b) disabling entering of accurate (older) date and time, after forming a new record in the fiscal memory after entering wrong (newer) date and time.

Various unregistered misuses of printing of non-fiscal receipts (non-fiscal invoices, kitchen orders and bar orders) with names and prices of goods and services from fiscal receipts, are possible on some fiscal registers, wherein non-fiscal receipts can be printed on:

a) fiscal register;

b) additional non-fiscal printer, connected with the fiscal register; and

c) additional non-fiscal printer, connected with PC or POS system.

The consequences of mentioned misuses of printing are:

a) misleading of a buyer of goods and services that he or she received real fiscal receipt;

b) avoidance of data printing about sold goods and services on the journal tape (if exists) or their storage into the journal memory (if exists); and

c) avoidance of summing and storage of turnovers of sold goods and services into the fiscal memory.

Various unregistered misuses of displaying false amounts for the payment onto buyer's display are possible on some fiscal registers:

a) displaying intermediate sum on the buyer's display before displaying final amount for the payment, and after actual payment canceling a part or even all sold goods and services; and

b) displaying alphanumeric message with the amount for the payment on the buyer's display received from PC or PUS system instead of the amount for the payment from the fiscal register.

The consequences of mentioned misuses of displaying are:

a) misleading of a buyer of goods and services to pay the amount shown on the buyer's display;

b) avoidance of printing of data about sold goods and services on the journal tape (if exists) and their storage into the journal memory (if exists); and

c) avoidance of summing and storage of turnovers of sold goods and services into the fiscal memory.

Major disadvantages of fiscal registers with transactions stored in the journal memory are:

a) removal of full journal memory;

b) storage of full journal memory;

c) assembling of new empty journal memory with associated expenses; and

d) missing authentication of stored transactions.

Possible unregistered misuses of the journal memory on fiscal registers with the journal memory that is accessible without removal of the service seal and without opening of the fiscal register, are:

a) removal of the original journal memory and assembly of a counterfeited journal memory;

b) change of individual recorded transactions of sold goods and services from fiscal receipts and change of the appropriate additional written data (usually a checksum) in the journal memory;

c) damage of the journal memory, in order to prevent its reading during audit; and

d) hiding, damage or destruction of already removed (usually full) journal memory, in order to prevent its reading for audit purposes.

Major disadvantages of fiscal registers with transactions printed on a journal tape are:

a) storage of a huge number of printed journal tapes for years and their protection from heat, sun, fire, humidity, fungi, insects, rodents, etc. in warehouses, where they consume space;

b) only summary information about daily turnovers is in the fiscal memory, while for the audit, a detailed information about transactions is necessary which is printed on journal tapes;

c) manual inspection of a huge number of printed journal tapes and searching of individual transactions requires enormous effort and time of tax inspectors, so it is rarely used; and

d) missing authentication of printed journal tapes.

Possible unregistered misuses of printed journal tapes (if exist) on fiscal registers are:

a) hiding, damage or destruction of printed journal tapes, in order to prevent their reading for audit purposes; and

b) printing of counterfeited journal tapes, on a separate printer, wherein the sum of individual turnovers can be appropriate to a counterfeited daily report.

Possible unregistered misuses of printed daily reports on fiscal registers are:

a) hiding, damage or destruction of printed daily reports, in order to prevent their reading for audit purposes;

b) printing of counterfeited daily reports, on a separate printer; and

c) intentional physical destruction, damage and disabling of fiscal registers, stealing and force majeure effect (flood, fire, earthquake, lighting, traffic accident, etc.), wherein all data stored in the fiscal memory from the moment of fiscalization are irretrievably lost.

Data security in the fiscal register can be compromised even in case that the certification of its hardware and software was perfectly done, due to insufficient safety of its construction in a combination with too wide authority of servicemen and too much relying on law obeying by tax payers.

Unregistered access to electronic components is possible on some fiscal registers with all consequences resulted from the removal of the service seal and opening of the enclosure:

a) access through existing holes for: cooling, cable passing, additional unassembled keyboard, additional connections with unassembled port and similar; and

b) access through partially open enclosure of the fiscal register, thanks to temporarily elastic deformation of a soft plastic of the enclosure, hidden hatches below stickers, a hole resulted from a disassembly of the keyboard, the display or the printer, and similar.

Possible various unregistered misuses after the removal of the service seal are:

a) removal of the original microcontroller and assembly of a counterfeited microcontroller with an additional embedded counterfeited program in internal EEPROM or FLASH memory; and

b) disable of a protection of the microcontroller from a change of data in internal EEPROM or FLASH memory by short-circuiting or disconnecting components or inserting a new component, e.g. a resistor.

Possible unregistered misuses of the operating memory after the removal of the service seal by short-circuiting or disconnecting components or inserting a new component, e.g. a resistor, are:

a) clear of the content of the operating memory comprising data about individual and summed turnovers per day with writing of date and time of that clearing in the fiscal memory;

b) unregistered disabling of a detector of a low power supply voltage of the operating memory and clearing of the content of the operating memory comprising data about individual and summed turnovers per day without writing of date and time of that clearing in the fiscal memory; and

c) unregistered disabling of a reset detector of the operating memory comprising data about individual and summed turnovers during day without writing of date and time of that reset in the fiscal memory.

Possible unregistered misuses of the journal memory (if exists) after the removal of the service seal, are:

a) removal of the original journal memory and assembling of a counterfeited journal memory;

b) change of individual data about sold goods and services from fiscal receipts and change of the appropriate additional written data (usually a checksum) in the journal memory;

c) damage of the journal memory, in order to prevent its reading during audit; and

d) hiding, damage or destruction of already removed (usually full) journal memory, in order to prevent its reading for audit purposes.

Unregistered assembly of a service seal after unregistered removal of the service seal can be performed in several manners:

a) unregistered assembly of the original service seal by an authorized serviceman in a deal with the tax payer;

b) return of the same service seal without damage; and

c) assembly of a counterfeited service seal.

In a typical case of the realization of the service seal using soft material assembled on a screw, returned service seal even does not need to be completely exact to the original, since the surface of the service seal is easily deformable by the accident pressure, which happens and is tolerated in practice.

Unregistered misuses of the program memory are possible after removal of the program seal (if actually assembled):

a) removal of the original program memory and assembly of a counterfeited program memory with a program with an embedded misuse;

b) clear of a program in the program memory of EPROM type through a quartz window;

c) clear and change of a program in the program memory of EEPROM and FLASH type with a circuit for the prevention of the erasure of written data after a modification of that circuit by short-circuiting or disconnecting components or inserting a new component, e.g. a resistor; and

d) damage of the program memory, in order to prevent its reading during audit.

Unregistered assembly of a program seal after unregistered removal of the program seal (if actually assembled) can be performed in several manners:

a) unregistered assembly of a new original program seal by an authorized serviceman in a deal with the tax payer;

b) return of the same program seal without damage; and

c) assembly of a counterfeited program seal.

In a typical case of the realization of the program seal using a sticker, assembly of a new original program seal requires writing of marking of the program seal into a service booklet in the presence of a tax inspector.

Possible unregistered misuses of the fiscal memory after the removal of the fiscal seal (if actually assembled), are:

a) write of a counterfeited data into the fiscal memory; and

b) damage of the fiscal memory, in order to prevent its reading during audit.

Unregistered assembly of a fiscal seal after unregistered removal of the fiscal seal (if actually assembled) can be performed in several manners:

a) unregistered assembly of a new original fiscal seal by an authorized serviceman in a deal with the tax payer;

b) return of the same fiscal seal without damage; and

c) assembly of a counterfeited fiscal seal.

In a typical case of the realization of the fiscal seal using a sticker, assembly of a new original fiscal seal requires writing of marking of the fiscal seal into a service booklet in the presence of a tax inspector.

Unregistered removal of a hardened compound for coating the fiscal memory can be performed in several manners:

a) removal of a hardened compound around screws which hold a module with the fiscal memory;

b) partial removal of the hardened compound around a module with the fiscal memory; and

c) complete removal of the hardened compound around a module with the fiscal memory.

In a typical case of the realization of the hardened compound, the compound can be removed without visible damage of the enclosure of the fiscal register.

Unregistered coating of the fiscal memory with a hardened compound after unregistered removal of the hardened compound for coating the fiscal memory is performed easily.

Unregistered misuses of the fiscal memory are possible after the removal of the fiscal seal (if actually assembled) and removal of the hardened compound for coating the fiscal memory:

a) removal of the original fiscal memory and assembly of a counterfeited fiscal memory with the same written identification number;

b) clear of data in the fiscal memory of EPROM type through a quartz window;

c) clear and change of data in the fiscal memory of EEPROM and FLASH type with a circuit for the prevention of the erasure of written data after a modification of that circuit by connecting or disconnecting components or inserting a new component, e.g. a resistor; and

d) damage of the fiscal memory, in order to prevent its reading during audit.

Besides aforementioned, other misuses of fiscal registers are possible which are not so well known, and which cover, besides others, disable, damage and destruction of particular parts of the fiscal register relevant for the prevention of misuses during turnover registration.

Many previously mentioned misuses cannot be detected without the removal of the service seal, opening of the fiscal register, comparison of the fiscal register with a certified fiscal register guarded in the relevant government institution and detailed inspection by experts, which causes additional expenses and requires additional time. However, some misuses can pass unnoticed even for experts, like a change of electronic components (microcontrollers or memories), in case that markings of the original and the counterfeited electronic component are identical or are different for a small number of characters (in some cases only one), or are even erased. Also, various complicated formats of electronic and printed data slow down or even prevent audit.

Data security and data authentication of non-fiscal registers is minimal due to little or not at all responsibility of manufacturers, distributors and servicemen towards government institutions, as well as their wish for bigger sales, i.e. profit, which leads to the appearance of, so-called, “popular” registers at the market, which in direct or indirect manner enable misuses during turnover registration.

Because of this, various unregistered misuses of non-fiscal registers, PC, POS system and back office server are possible, which can be activated without a trace through a menu or a keyboard, i.e. without opening of an enclosure, because they are even publicly or secretly supported in the original program, and which is almost impossible to be successfully controlled, because there is no certification from the side of appropriate government institutions before their use, nor any other security means, like performance bonds:

a) printing of receipts in a training mode without storing data about individual sold goods and services onto the journal tape (if exists) or the journal memory (if exists), without summing and storing turnovers of sold goods and services in data memory or a hard disk, in order to mislead buyer of goods or services that he or she received a real receipt;

b) non-printing, change or clear of data about individual sold goods and services which are already written into the journal memory or a hard disk;

c) non-printing, change or clear of counters and labels of counters of individual sold goods and services;

d) non-printing, change or clear of summed turnovers of sold goods and services, which are already written in a data memory or a hard disk;

e) non-printing, change or clear of counters and labels of counters of summed turnovers of sold goods and services;

f) non-printing, change or clear of: journal reports, daily (Z) reports, X-reports and periodic reports;

g) non-printing, change or clear of counters and labels of counters of: journal reports, daily (Z) reports, X-reports and periodic reports;

h) activation of additional programs for performing already mentioned misuses on PC or POS system instead of original programs or in parallel with original programs; and

i) utilization of unregistered non-fiscal registers for turnover registration; as well as many other misuses, which are not so well known.

All mentioned misuses of fiscal registers and non-fiscal registers are solved by this disclosure.

The first object of this disclosure is to provide a new construction of the turnover controller in comparison with state-of-the-art fiscal cash registers, fiscal printers, non-fiscal cash registers and non-fiscal printers, using grouping of its parts into two sets of parts.

The second object of this disclosure is to provide a first opening controller for a first enclosure, wherein the authorization, date and time of each opening and closing of the first enclosure are automatically registered in the log memory, and each unauthorized opening of the first enclosure can additionally result in disabling further turnover registration.

The third object of this disclosure is to provide a second opening controller for a second enclosure, wherein the authorization, date and time of each opening and closing of the second enclosure are automatically registered in the log memory, and each unauthorized opening of the second enclosure can additionally result in disabling further turnover registration.

The fourth object of this disclosure is to provide an encrypted communication between the first set of parts and particular parts from the second set of parts, due to the assembly of microcontrollers with encryption and decryption within parts from the second set of parts, which are registered by the microprocessor with encryption and decryption from the first set of parts.

The fifth object of this disclosure is to provide the authentication, registering the turnover controller on a server and the activation of the approval for turnover registration by the turnover controller.

The sixth object of this disclosure is to provide the authentication, deregistering the turnover controller on a server and the activation of the disapproval for turnover registration by the turnover controller.

The seventh object of this disclosure is to provide automatic update of a program in the program memory using received file with the program from the server.

The eight object of this disclosure is to enable update of commands in the log memory using received command file from the server, which additionally enable compliance to the requirements of the appropriate legislation without program change.

The ninth object of this disclosure is to enable update of tax rates in the log memory using received command file from the server.

The tenth object of this disclosure is to enable update of PLU base in the PLU memory, using received file with PLU base from the server, which for each PLU comprises: PLU code, PLU name, tax rate assigned to PLU, name of PLU metric unit and price of PLU metric unit.

The eleventh object of this disclosure is to enable reuse of the capacity of the log memory, which is expressed in predefined number of records for sending to the server about: tax payers, sales locations, errors, services and resets, as well as records received from the server with: commands, programs and tax rates.

The twelfth object of this disclosure is to enable reuse of the capacity of the PLU memory, which is expressed in predefined number of PLUs in PLU base.

The thirteenth object of this disclosure is to enable reuse of the capacity of the transaction memory, which is expressed in predefined number of: individual registered transactions, individual cancelled registered transactions, individual refunded transactions and individual cancelled refunded transactions.

The fourteenth object of this disclosure is to enable reuse of the capacity of the turnover memory, which is expressed in predefined number of: summed recorded turnover, summed cancelled recorded turnover, summed refunded turnover and summed cancelled refunded turnover.

The fifteenth object of this disclosure is the automatic synchronization of the real-time clock of the turnover controller with a real-time clock of the server.

The sixteenth object of this disclosure is to enable local checking of authenticity and correct operation of the turnover controller, on the basis of self-testing assigned through the keyboard, wired or wireless port and an analysis of the results of self-test on the turnover controller, without necessity for detailed knowledge or usage of printed user manual.

The seventeenth object of this disclosure is to enable remote checking of authenticity and correct operation of the turnover controller, on the basis of self-testing assigned through the server and an analysis of the results of self-test on the server, without necessity for detailed knowledge or usage of printed user manual.

The eighteenth object of this disclosure is to provide authenticity of not only records in memories, but also printed fiscal documents (fiscal receipt, refunded receipt, X-report, daily report and periodic report) due to a digital signature.

The nineteenth object of this disclosure is to provide a connection of additional non-fiscal printers (such as a kitchen printer or a bar printer) directly to wired or wireless port of the turnover controller, instead to PC or POS system.

The twentieth object of this disclosure is to provide control of turnover registration performed by tax payers, even in case that particular turnover controller is disabled, damaged or destroyed, because of data that have been already sent to the server.

### BRIEF DESCRIPTION OF THE DRAWINGS

The other parts and the preferred embodiments of this disclosure will be further described in detail in connection with the accompanying drawings in which:

FIG. 1 is a block diagram of a state-of-the-art fiscal cash register or fiscal printer.

FIG. 2 is a block diagram of a first embodiment of the turnover controller according to this disclosure.

FIG. 3 is a block diagram of a second embodiment of the turnover controller according to this disclosure.

FIG. 4 is a block diagram of a third embodiment of the turnover controller according to this disclosure.

FIG. 5 is a block diagram of a fourth embodiment of the turnover controller according to this disclosure.

FIG. 6 is a block diagram of a fifth embodiment of the turnover controller according to this disclosure.

FIG. 7 is a block diagram of a sixth embodiment of the turnover controller according to this disclosure.

FIG. 8 is a block diagram of a connection of a plurality of turnover controllers to a server.

### DETAILED DESCRIPTION OF EXEMPLARY EMBODIMENTS

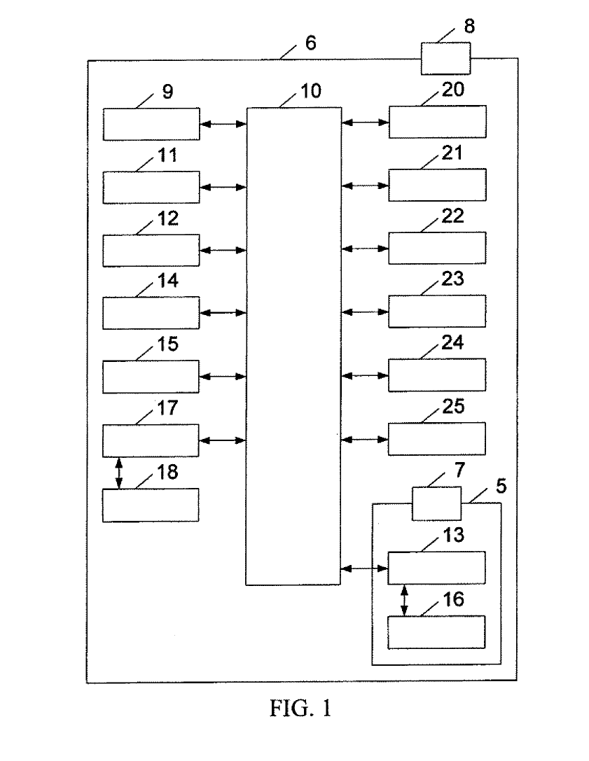

FIG. 1 is a block diagram of a state-of-the-art fiscal register, wherein in order to simplify comparison with embodiments of the turnover controller 2, part names of the turnover controller 2 are used, and equivalent names of similar parts of a fiscal register are provided in the brackets. A log memory 13 and a turnover memory 16 (which together form the fiscal memory) are assembled in a first enclosure 5 (fiscal module), which opening is prevented by a first opening controller 7 (fiscal seal and hardening compound).

All other parts: a microprocessor supervisor 9, a microprocessor 10, a program memory 11, an operating memory 12, a PLU memory with data about goods and services 14, a transaction memory 15 (journal memory, if exists), a real-time clock 17, a backup battery 18, a keyboard 20, a display 21, a printer 22, a power supply 23, a seller's display 24 and a wired port 25, as well as complete first enclosure 5 are assembled in a second enclosure 6 (register's enclosure), which opening is prevented by a second opening controller 8 (service seal).

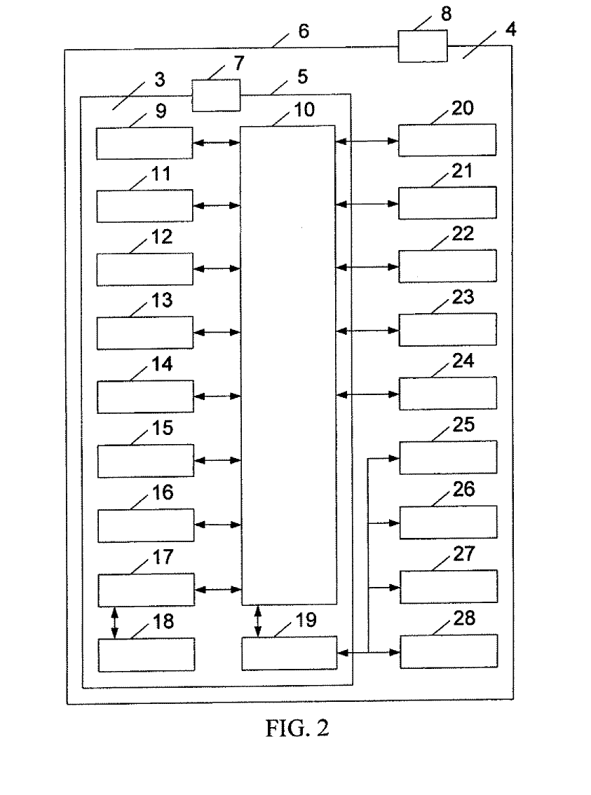

FIG. 2 is a block diagram of a first embodiment of the turnover controller 2 according to this disclosure. A first set of parts 3 of the turnover controller 2 (a microprocessor supervisor 9, a microprocessor 10, a program memory 11, an operating memory 12, a log memory 13, a PLU memory 14, a transaction memory 15, a turnover memory 16, a real-time clock memory 17, a backup battery 18 for supplying at least one part of the first set of parts 3, a communication device 19, internal connectors, etc.), which are most important for the prevention of misuses during turnover registration, and at the same time exceptionally reliable, thus do not requiring servicing in practice, can be assembled in the first enclosure 5.

The microprocessor supervisor 9 usually comprises: a generator of reset during power on, power off and power brownout of supply voltage of the microprocessor 10, an optional generator of unmasked interrupt during power off and power brownout of supply voltage of the microprocessor 10 and an optional “watchdog” timer for the generation of interrupts in case that particular parts of program code are not executed within a predefined time interval.

The program memory 11 can be typically realized as: EEPROM or FLASH memory, in case that program update is supported. The program memory 11 can be typically realized as: PROM, OTPROM, EPROM, EEPROM or FLASH with a circuit for the erasure prevention, in case that program update is not supported.

The program of the turnover controller 2 inside the program memory 11 can be updated completely, or be divided into two parts: a basic program without update capability, which provides updating of other programs and registering the turnover controller 2 at a server 1, as well as additional programs with update capability, which provides turnover registration and operations with PLU base, and also all other operations, such as, for example: recharging of SIM prepaid cards for mobile phones, payment of lotto combinations, advertising on an additional monitor, etc.). This can prevent possibility of the existence of different programs in the turnover controllers 2 in the same state, some of them might be counterfeited.

The operating memory 12 can be typically realized as: SRAM or DRAM with a backup battery or NVRAM.

The log memory 13 can be realized as: EEPROM or FLASH memory, in ease that log memory 13 management supports FIFO (first-in-first-overwritten) mode of the operation. The log memory 13 can be realized as: PROM, EPROM, OTPROM, EEPROM or FLASH memory with a circuit for the erasure prevention, in case that the log memory 13 management does not support FIFO mode of the operation.

Using the log memory 13 in FIFO mode of the operation according to this disclosure, new records of a particular type for sending to the server 1 are written in the log memory 13 over already written oldest records of that type, under the condition that these already written records have been already sent to the server 1. On the contrary, the log memory 13 is considered full and disable further entering of records of that type inside the turnover controller 2, thus avoiding data loss in case of impossible receipt of data on the server 1. Using the log memory 13 in FIFO mode of the operation according to this disclosure, new records of the particular type received from the server 1 are written in the log memory 13 over already written oldest records of the same type.

The PLU memory 14 can be realized as EEPROM or FLASH memory, as well as SRAM or DRAM with backup battery.

Using the PLU memory 14 in FIFO mode of the operation according to this disclosure, new PLU is written in the PLU memory 14 over oldest already written PLU.

The transaction memory 15 can be typically realized as: EEPROM or FLASH memory, in case that the transaction memory 15 management supports FIFO mode of the operation. The transaction memory 15 can be typically realized as: PROM, OTPROM, EPROM, EEPROM or FLASH with a circuit for the erasure prevention, in case that the transaction memory 15 management does not support FIFO mode of the operation.

Using the transaction memory 15 in FIFO mode of the operation according to this disclosure, new transactions are written over already written oldest transactions, under the condition that these already written transactions have been already sent to the server 1. On the contrary, the transaction memory 15 is considered full and disable further turnover registration by the turnover controller 2, which avoids data loss in case of impossible receipt of data on the server 1.

The turnover memory 16 can be typically realized as: EEPROM or FLASH memory, in case that the turnover memory 16 management supports FIFO mode of the operation. The turnover memory 16 can be typically realized as: PROM, OTPROM, EPROM, EEPROM or FLASH with a circuit for the erasure prevention, in case that the turnover memory 16 management does not support FIFO mode of the operation.

Using the turnover memory 16 in FIFO mode of the operation according to this disclosure, new turnovers are written over already written oldest turnovers, under the condition that these already written turnovers have been already sent to the server 1. On the contrary, the turnover memory 16 is considered full and disable further turnover registration by the turnover controller 2, which avoids data loss in case of impossible receipt of data on the server 1.

At least two memories of these memories: the program memory 11, the operating memory 12, the log memory 13, the PLU memory 14, the transaction memory 15 and the turnover memory 16 can be realized in the common integrated circuit.

Considering that the amounts of fines are limited, intentional data loss in a fiscal register and a non-fiscal register during long time interval of, for example, 5 years, will have the same regulated fine as well as intentional data loss in the turnover controller 2 in short time interval between two successive sending of data to the server 1 of, several minutes to several days.

The communication device 19 can be: (a) a wireless communication device; (b) mobile phone; (c) GPRS (General Packet Radio Service) communication device; (d) EDGE (Enhanced Data rates for GSM Evolution) communication device; (e) UMTS/3G (Universal Mobile Telecommunications System) communication device; (f) UMTS/4G (Universal Mobile Telecommunications System) communication device; (g) CDMA 2000 (Code Division Multiplex Access) communication device; (h) HSDPA (High Speed Downlink Packet Access) communication device; (i) WiMAX (IEEE 802.16) communication device; (j) WiFi (IEEE 802.11) communication device; (k) satellite communication device; (l) wired communication device; (m) POTS (Plain Old Telephone Service) communication device; (n) ISDN (Integrated Services Digital Network) communication device; (o) ADSL/ADSL+ (Asymmetric Digital Subscriber Line) communication device; (p) ADSL2/ADSL2+ (Asymmetric Digital Subscriber Line 2) communication device; (q) HDSL (High Data Rate Digital Subscriber Line) communication device; (r) SDSL (Symmetric Digital Subscriber Line) communication device; (s) RADSL (Rate-Adaptive Digital Subscriber Line) communication device; (t) VDSL (Very High Speed Digital Subscriber Line) communication device; (u) VDSL 2 (Very High Speed Digital Subscriber Line 2) communication device; (v) G.SHDSL (Symmetric High-Speed Digital Subscriber Line) communication device; (w) PDSL (Powerline Digital Subscriber Line) communication device; (x) UDSL (Uni Digital Subscriber Line) communication device; (y) cable communication device; and (z) a communication part of any communication device.

A second set of parts 4 of the turnover controller 2 (a keyboard 20, a display 21, a printer 22, a power supply 23, a seller's display 24, a wired port 25, a wireless port 26, an antenna 27, a SIM card 28 and external connectors, etc.), which are less important for the prevention of misuse during turnover registration, and at the same time less reliable, thus requiring servicing in practice, i.e. possibility for a change, can be assembled in at least one second enclosure 6.

The turnover controller 2 for controlling turnover can comprise: (a) the first set of parts 3 comprising: the microprocessor 10, the program memory 11, the operating memory 12, the log memory 13, the PLU memory 14, the transaction memory 15, the turnover memory 16, the real-time clock 17, the backup battery 18 for supplying at least one part of the turnover controller 2; and (b) the second set of parts 4 comprising: the keyboard 20, the display 21 and the printer 22, wherein: the first set of parts 3 is assembled into the first enclosure 5, which opening is controlled using a first opening controller 7; parts from the second set of parts 4 are assembled into at least one second enclosure 6, which opening is controlled using at least one second opening controller 8; and the first set of parts 3 and the second set of parts 4 are connected in order to enable turnover control.

At least one part of the turnover controller 2 can be selected from a group of parts comprising: (a) the communication device 19; (b) the power supply 23; (c) the seller's display 24; (d) the wired port 25; (e) the wireless port 26; (f) the antenna 27; (g) the SIM card 28; and (h) the microprocessor supervisor 9.

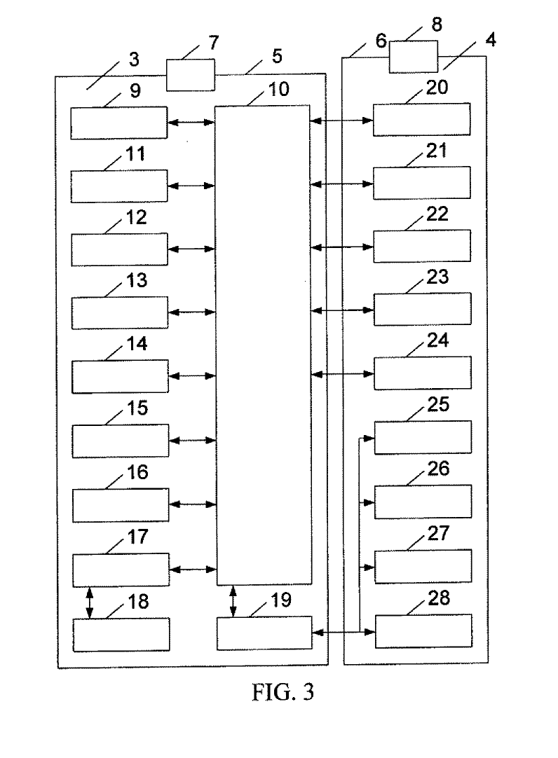

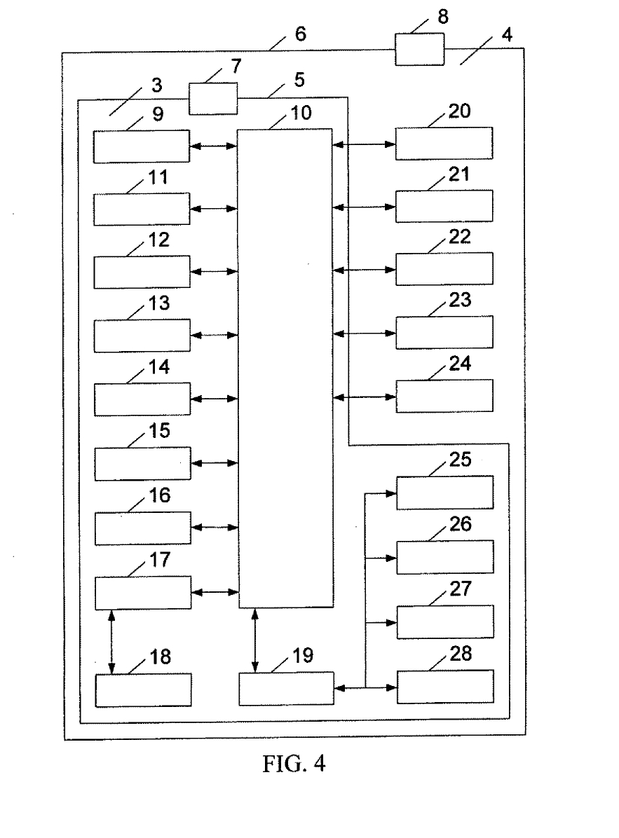

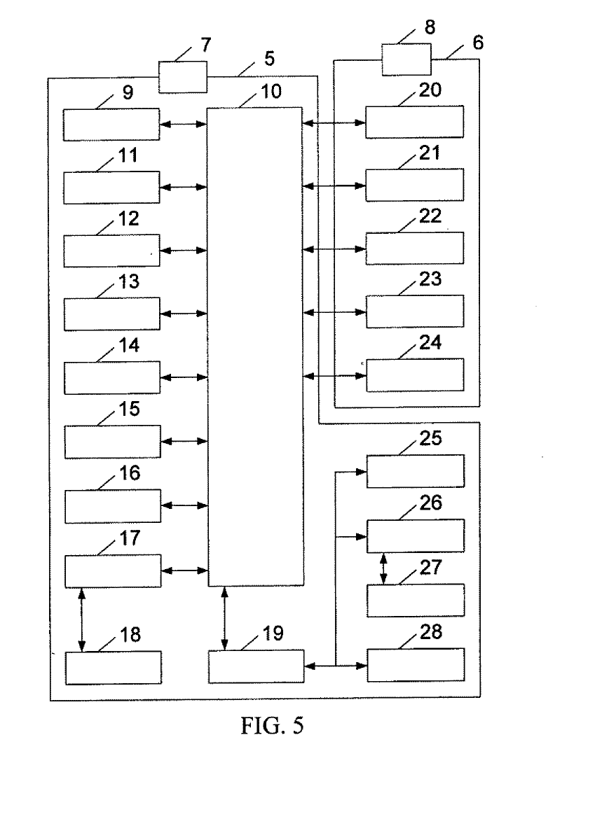

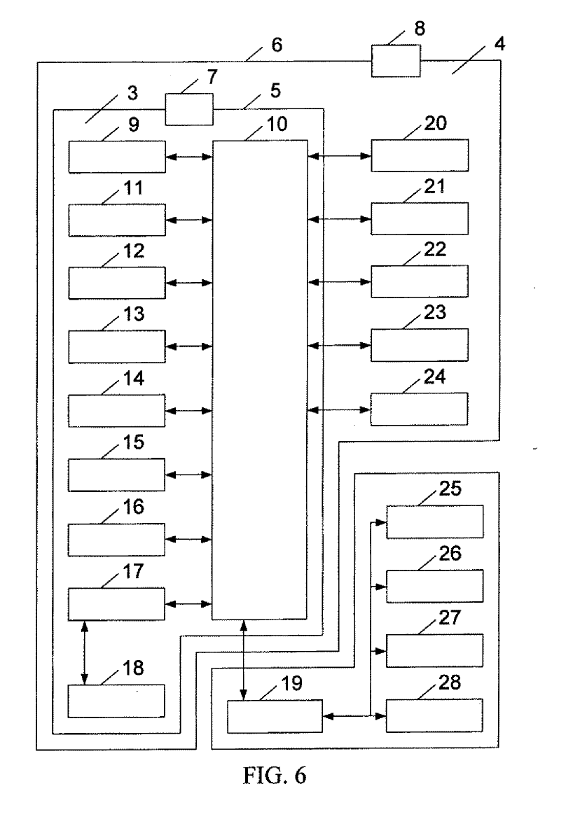

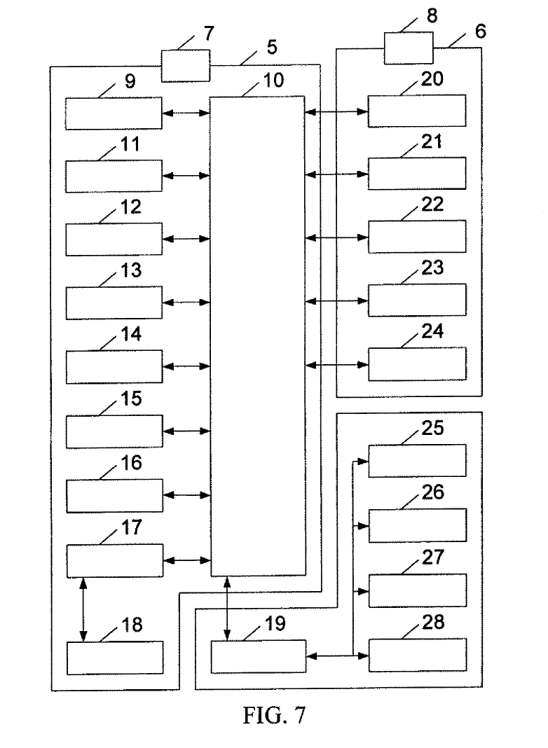

The first enclosure 5 can be assembled inside the second enclosure 6, as in FIG. 2, FIG. 4 and FIG. 6 or outside of the second enclosure 6, as in FIG. 3, FIG. 5 and FIG. 7.

The communication device 19, the wired port 25, the wireless port 26, the antenna 27 and the SIM card 28 can be also assembled inside the first enclosure 5, as in FIG. 4 and FIG. 5, or can be assembled inside one of the second enclosures, as in FIG. 6 and FIG. 7.

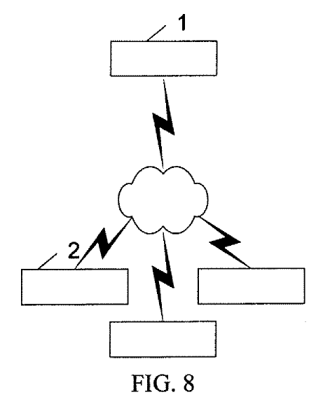

The server 1 can be connected through an appropriate network to a plurality of turnover controllers, one of which represents the turnover controller 2 in FIG. 8.

The first opening controller 7 and the second opening controller 8 can comprise means for access control selected from a group of means comprising: (a) special screw seal; (b) sealed wire passing through screw head; (c) seal-sticker put on an enclosure lid; (d) mechanical key; (e) electronic contact key; (f) electronic contactless key; (g) combination of mechanical and electronic contact key; (h) combination of mechanical and electronic contactless key; (i) keyboard for entering code sequence; (j) keyboard for entering code sequence using coded duration of particular keys; (k) unintelligent access card, which comprises: card with magnetic stripe, barium ferrite and wiegand-effect, passive and active proximity cards; (l) intelligent access cards, which comprises: contact intelligent cards and RFID intelligent cards; (m) fingerprint recognition device; (n) hand geometry recognition device; (o) face recognition device; (p) iris recognition device; (q) voice recognition device; (r) dynamic signature recognition device; (s) vein scan recognition device; (t) face thermography recognition device; (u) skin pattern recognition device; (v) nail bed recognition device; (w) blood pulse measurement recognition device; (x) biometric sensor; (y) means for the prevention of opening of a enclosure; and (z) means for enabling opening of a enclosure, wherein a way of the activation of access control device (d) to (x) generates authorization type.

Opening of the first enclosure 5 and servicing of the first set of parts 3 can be disabled, which provides maximum data security. Opening of the first enclosure 5 can be controlled by first opening controller 7 of the first enclosure 5, so that access is allowed only to a person authorized by the manufacturer (e.g. a serviceman in a central service of the manufacturer).

Opening of the second enclosure 6 and servicing of the second set of parts 4 can be completely free, such that servicing is reduced to a simple change of parts which can be performed even by a person unauthorized from the manufacturer. Opening of the second enclosure 6 can be controlled by the second opening controller 8 of the second enclosure 6, such that the access is allowed only to a person authorized by the manufacturer (e.g. a serviceman in a central service of the manufacturer or a serviceman in a local service of the manufacturer).

The first set of parts 3 can be connected with the second set of parts 4 using at least one cable, which disconnection is controlled by at least one means chosen from the group of means comprising: (a) the first opening controller 7; and (b) at least one second opening controller 8.

The realizations of the first set of parts 3 can use protection mechanisms applied in:

a) IBM 3848 and VISA security modules with a microprocessor in the robust metal enclosures, which opening shuts down the power supply, which erases sensitive data (e.g. encryption and decryption keys);

b) IBM μABYSS security module with thin wire around a microprocessor which is assembled before coating it by an epoxy resin, and which breaking erases sensitive data; and

c) IBM 4764 and IBM 4758 security modules, which microprocessor is embedded inside four layer overlapping zig-zag conducting pattern doped into a polyurethane sheet which in turn is coated by a chemically similar substance, making it very difficult to detect the conductive path. Also, this module measures temperature changes and erases sensitive data at low temperatures, since temperature decrease leads down to holding memory content during several minutes, which is enough for the physical attack through the protective layers. In addition to that, this module measures X-rays using a radiation sensor and erases sensitive data in case of a radiation. The electromagnetic radiation from the module is prevented by the aluminum shield. The variations in power supply current showing a type of the operation which microprocessor executes, are eliminated using low-pass filter.

At least one part from the second set of parts 4 can additionally comprise a microcontroller which supports data encryption and decryption for interfacing with the first set of parts 3.

Encrypted communication between parts of the turnover controller 2 prevents misuse of the turnover controller 2 even in case of free opening of the second enclosure 6, since neither one of the second set of parts 4 can be extracted and exchanged for a counterfeited part enabling misuse, because it cannot communicate with the first set of parts 3. However, exchange of any defective part of the second set of parts 4 with the original part is possible, since microprocessor from the first set of parts 3 can automatically deregister old original part from the second set of parts 4 and automatically register new original part from the second set of parts 4. This also prevents exchange of the first set of parts 3 with a counterfeited first set of parts enabling misuse, because it cannot communicate with original parts from the second set of parts 4, neither communicate with the server 1. However, exchange of the first set of parts 3 is also possible, such that the microprocessor 10 from new first set of parts 3 accepts existing registrations of old original parts from the second set of parts 4, on the basis of data from the server 1.

Symmetric encryption and decryption utilizes secret keys which all parts of the turnover controller 2 have in advance, e.g. written during production. The advantage of symmetric encryption is fast execution, and disadvantage is initial distribution of symmetric keys.

Asymmetric encryption and decryption utilizes public and private pair of keys. Each part for the encryption of transmitted data utilizes public key of a receiving part, and for the decryption of received data utilizes its own private key. The advantage of asymmetric encryption is that parts do not need to have initial distributed keys, and the disadvantage is processing speed and the verification of the certificate of a receiving part.

The manufacturer of the turnover controller 2 can send to the server 1 over a separate encrypted communication channel a list of parts assembled into the turnover controller 2, and a list of spare parts intended for assembly into the turnover controller 2. The server 1 also sends, if necessary, a new key encrypted with an existing key, to the manufacturer of the turnover controller 2.

Mentioned lists of parts minimally comprise production number of a part, a secret key for that part in case of a symmetric encryption, or a public key for that part in case of an asymmetric encryption. The server 1 sends, if necessary, a new key for the chosen part of the turnover controller 2 encrypted with an existing key, to the turnover controller 2.

The server 1 can also handle the register of assembled and disassembled parts of the turnover controller 2, and can prevent assembling of eventually counterfeited parts by this manner.

The server 1 can also change a key of the chosen part or all parts of the turnover controller 2 immediately after registering the turnover controller 2, and can prevent later assembly of eventually cloned parts by this manner.

The recommended manner of registering the turnover controller 2 on the server 1 is two-phased and is performed by the manufacturer of the turnover controller 2 and a tax payer.

The manufacturer of the turnover controller 2 performs the first registration of the turnover controller 2 on the server 1 after entering an authentication code of the manufacturer of the turnover controller 2 in the turnover controller 2, upon which the server 1 writes into the turnover controller 2 an unique identification number of the turnover controller 2. The authentication code of the manufacturer of the turnover controller 2 is typically given from the competent authority in a particular state and can be the same for all turnover controllers of that manufacturer, different for each type of turnover controllers, different for each group of turnover controllers or different for each particular turnover controller.

Using the first registration, errors during manual entering of the identification number of the turnover controller 2 in the turnover controller 2 are prevented, as well as the appearance of identical identification numbers of the turnover controller 2, and also it is possible to plan a speed of the implementation of turnover controllers 2 within a particular state. The additional security measure represents the prevention of the first registration in case that:

a) the turnover controller 2 is not reporting from an electronic address from the range of electronic addresses assigned to the manufacturer of the turnover controller 2;

b) the turnover controller 2 is not present at the distribution location which is reported to the competent authority in a particular state;

c) at least one part of the turnover controller 2 is not on a list of parts assembled into the turnover controller 2; and

d) at least one part of the turnover controller 2 cannot communicate with the first set of parts 3 or the server 1 using encryption and decryption keys from the list of parts assembled into the turnover controller 2.

A tax payer performs the second registration of the turnover controller 2 on the server 1 after entering an authentication code of the tax payer into the turnover controller 2, upon which the server 1 writes into the turnover controller 2 of the tax payer a unique identification code of the tax payer. The authentication code of the tax payer is typically given from the competent authority in a particular state and can be the same for all turnover controllers of that tax payer, different for each type of turnover controllers, different for each group of turnover controllers or different for each particular turnover controller.

Using the second registration, errors during manual entering of the identification number of the tax payer into the turnover controller 2 are prevented, as well as the appearance of identical identification numbers of tax payers in turnover controllers 2 of different tax payers, and also it is possible to track speed of the implementation of turnover controllers 2 within a particular state. The additional security measure represents the prevention of the second registration in case that:

a) the turnover controller 2 is not reporting from an electronic address from the range of electronic addresses assigned to the tax payer;

b) the turnover controller 2 is not present at the sale location which is reported to the competent authority in a particular state;

c) at least one part of the turnover controller 2 is not on the list of parts assembled into the turnover controller 2; and

d) at least one part of the turnover controller 2 cannot communicate with the first set of parts 3 or the server 1 using encryption and decryption keys from the list of parts assembled into the turnover controller 2.

The recommended manner of deregistering the turnover controller 2 on the server 1 is two-phased and is performed by the manufacturer of the turnover controller 2 and the tax payer.

The tax payer performs the first deregistration of the turnover controller 2 on the server 1 after entering an authentication code of the tax payer into the turnover controller 2, upon which the server 1 writes into the turnover controller 2 of the tax payer a predefined identification number of the tax payer. After the first deregistration, it is possible to register the same turnover controller 2 for another tax payer in the same state. The additional security measure represents prevention of the first deregistration in case that:

a) the turnover controller 2 is not reporting from an electronic address from the range of electronic addresses assigned to the tax payer;

b) the turnover controller 2 is not present at the sale location which is reported to the competent authority in a particular state;

c) at least one part of the turnover controller 2 is not on the list of parts assembled into the turnover controller 2; and

d) at least one part of the turnover controller 2 cannot communicate with the first set of parts 3 or the server 1 using encryption and decryption keys from the list of parts assembled into the turnover controller 2.

The manufacturer of the turnover controller 2 performs the second deregistration of the turnover controller 2 on the server 1 after entering an authentication code of the manufacturer of the turnover controller 2 in the turnover controller 2, upon which the server 1 writes into the turnover controller 2 a predefined identification number of the turnover controller 2. After the second deregistration, it is possible to register the same turnover controller 2 in another state, with update of the appropriate certified program from the server in that state. The additional security measure represents the prevention of the second deregistration in case that:

a) the turnover controller 2 is not reporting from an electronic address from the range of electronic addresses assigned to the manufacturer of the turnover controller 2;

b) the turnover controller 2 is not present at the distribution location which is reported to the competent authority in a particular state;

c) at least one part of the turnover controller 2 is not on the list of parts assembled into the turnover controller 2; and

d) at least one part of the turnover controller 2 cannot communicate with the first set of parts 3 or the server 1 using encryption and decryption keys from the list of parts assembled into the turnover controller 2.

The turnover controller 2 can receive key codes from at least one interface selected from a group of interfaces comprising: (a) the keyboard 20; (b) the communication device 19; (c) the wired port 25; (d) the wireless port 26; and (e) software self-test generator within a program in the program memory 11.

The turnover controller can be additionally connected with a device selected from a group of devices comprising: (a) PC; (b) POS; (c) card reader (POS-EFT); (d) bar code reader; (e) laser scanner; (f) additional monitor; (g) kitchen printer; (h) bar printer; (i) scale; (j) magnetic strip reader; (k) optical recognition character apparatus (OCRA); (l) machine vision camera; (m) RFID interrogator; and (n) GPS receiver.

The turnover controller 2 can also directly manage printing of non-fiscal documents on additional non-fiscal printers, upon a request of PC or POS system, which disables printing of non-fiscal documents looking like fiscal documents and which can mislead buyer of goods and services than he or she received a fiscal receipt. This also avoids complicated, long and expensive certification of a huge number of programs for PC or POS systems, using simple request that each additional non-fiscal printer must be connected directly to the turnover controller 2, and that it is forbidden its direct connection to PC or POS system.

The turnover controller 2 can perform a method of controlling turnover, comprising the steps of: (a) providing data security of a turnover controller 2; (b) data communicating between the turnover controller 2 and a server 1; (c) registering the turnover controller 2 on the server 1; and (d) turnover registration by the turnover controller 2.

Besides these steps, the method of controlling turnover can further comprise at least one step selected from a group of steps comprising: (a) deregistering the turnover controller 2 on the server 1; (b) self-testing of the turnover controller 2; (c) data exchange between the turnover controller of a seller and the turnover controller of a buyer; and (d) servicing of the turnover controller 2.

The data of the turnover controller 2 can comprise at least one type of record in the log memory 13 selected from a group of types of records comprising: (a) authentication code of the manufacturer of the turnover controller 2; (b) authentication code of a tax payer; (c) production number of the turnover controller 2; (d) production number of the first set of parts 3; (e) production number of parts from the second set of parts 4; (f) identification number of the turnover controller 2; (g) identification number of the tax payer; (h) name and address of the headquarters of the manufacturer of the turnover controller 2, date and time of entering name and address of the headquarters of the manufacturer; (i) name and address of a distribution location of the manufacturer of the turnover controller 2, date and time of entering name and address of the distribution location; (j) name and address of the headquarters of the tax payer, date and time of entering name and address of the headquarters of the tax payer; (k) name and address of a sale location of the tax payer, date and time of entering name and address of the sale location; (l) type of an error, date and time of error detection; (m) type of a service, date and time of beginning and end of the service; (n) type of a reset, date and time of reset activation; (o) type of a self-test, result of the self-test, date and time of the self-test; (p) type of an authorization, date and time of opening and closing of the first enclosure 5; (q) type of an authorization, date and time of opening and closing of at least one of the second enclosure 6; (r) serial number of a record in the log memory 13, date and time of sending a log file and date and time of receiving correct log file on the server 1; (s) serial number of a record in the transaction memory 15, date and time of sending a transaction file and date and time of receiving correct transaction file on the server 1; (t) serial number of a record in the turnover memory 16, date and time of sending a turnover file and date and time of receiving correct turnover file on the server 1; (u) commands, date and time of receiving commands in the turnover controller 2; (v) program signature, date and time of receiving a program in the turnover controller 2; and (w) tax rates, date and time of receiving tax rates in the turnover controller 2.

The identification number of the turnover controller 2 can comprise at least one identification code selected from a group of identification codes comprising: (a) identification code of a particular state in which the turnover controller 2 controls turnover; (b) identification code of the manufacturer of the turnover controller 2; (c) identification code of a type of the turnover controller 2; and (d) identification code of the turnover controller 2 itself.

The identification number of the tax payer can comprise at least one identification code selected from a group of identification codes comprising: (a) identification code of a particular state in which turnover of the tax payer is controlled; (b) unique identification code of the tax payer; (c) registered identification code of the tax payer for value added tax; and (d) registered identification code of the tax payer for sales tax.

At least one type of error can be selected from a group of errors comprising: (a) the turnover controller 2 is not registered on the server 1; (b) the turnover controller 2 is deregistered on the server 1; (c) the program memory 11 is defective; (d) the operating memory 12 is defective; (e) the log memory 13 is defective; (f) the PLU memory 14 is defective; (g) the transaction memory 15 is defective; (h) the turnover memory 16 is defective; (i) the keyboard 20 is defective; (j) the display 21 is defective; (k) the printer 22 is defective; (l) a paper tape is missing in the printer 22; (m) the power supply 23 voltage is higher than predefined overvoltage level; (n) the power supply 23 voltage is lower than predefined undervoltage level; (o) the seller's display 24 is defective; (p) a number of records of particular type in the log memory 13 reached predefined number for that type of records; (q) a number of records of particular type in the log memory 13 reached predefined number for that type of records, and all records of that type have not been sent to the server 1 before writing of new records of that type in the log memory 13; (r) a number of records of particular type in the transaction memory 14 reached predefined number for that type of records; (s) a number of records of particular type in the transaction memory 15 reached predefined number for that type of records, and all records of that type have not been sent to the server 1 before writing of new records of that type in the transaction memory 15; (t) a number of records of particular type in the turnover memory 16 reached predefined number for that type of records; and (u) a number of records of particular type in the turnover memory 16 reached predefined number for that type of records, and all records of that type have not been sent to the server 1 before writing of new records of that type in the turnover memory 16.

At least one type of service can be selected from a group of types of services comprising: (a) unjustified requested service; (b) technical inspection; (c) repair without opening of the first enclosure 5; (d) repair without opening of the second enclosure 6; (e) repair with opening of the first enclosure 5; (f) repair with opening of the second enclosure 6; (g) disassembly of at least one part of the second set of parts 4 after opening of the second enclosure 6; (h) assembly of at least one part of the second set of parts 4 after removal of at least part of the second set of parts 4; (i) disassembly of existing first set of parts 3 after opening of the first enclosure 5; and (j) assembly of new first set of parts 3 after removal of existing first set of parts 3.

At least one type of reset can be selected from a group of types of resets comprising: (a) program deblocking without clear of data relevant to turnover registration in the operating memory 12 based on received key code; (b) activation of predefined commands instead of last received commands from the server 1, after opening of the second enclosure 6 and entering request for the activation; and (c) complete clearing of the operating memory 12 after opening the first enclosure 5 and entering request for clearing.

At least one type of self-test is selected from a group of types of self-tests comprising: (a) self-test of the microprocessor 10; (b) self-test of the program memory 11; (c) self-test of the operating memory 12; (d) self-test of the log memory 13; (e) self-test of the PLU memory 14; (f) self-test of the transaction memory 15; (g) self-test of the turnover memory 16; (h) self-test of the communication device 19; (i) self-test of the keyboard 20; (j) self-test of the display 21; (k) self-test of the printer 22; (l) self-test of the power supply 23; (m) self-test of the seller's display 24; and (n) self-test of data exchange between the turnover controller 2 and the server 1.

At least one type of authorization can be selected from a group of types of authorizations comprising: (a) authorization for opening of the first enclosure 5; (b) non-authorization for opening of the first enclosure 5; (c) authorization for opening of the second enclosure 6; and (d) non-authorization for opening of the second enclosure 6.

At least one command can be selected from a group of commands comprising: (a) assignment of an identification number of the turnover controller 2; (b) assignment of an identification number of tax payer; (c) assignment of tax rates, date and time of beginning of validity of tax rates; (d) receiving a command file from the server 1; (e) receiving a program file from the server 1; (f) date and time for sending data to the server 1; (g) period and time for sending data to the server 1; (h) sending all data to the server 1; (i) sending data within requested time interval to the server 1; (j) sending unsent data to the server 1; (k) synchronization of date and time of the turnover controller 2 with the server 1; (l) self-test type; (m) status type; (n) sending a log file to the server 1; (o) sending a transaction file to the server 1; (p) sending a transaction file of selected PLUs to the server 1; (q) sending a turnover file to the server 1; (r) assignment of an encryption key for the first set of parts 3; and (s) assignment of an encryption key for parts of the second set of parts 4.

The status type can be selected from a group of status types comprising: (a) an approval of the registration of the turnover controller 2 on the server 1, in case of valid authentication code of the manufacturer of the turnover controller 2; (b) a disapproval of the registration of the turnover controller 2 on the server 1, in case of invalid authentication code of the manufacturer of the turnover controller 2; (c) an approval of the registration of the turnover controller 2 on the server 1, in case that an electronic address of the turnover controller 2 is within the range of electronic addresses assigned to the manufacturer of the turnover controller 2; (d) a disapproval of the registration of the turnover controller 2 on the server 1, in case that an electronic address of the turnover controller 2 is outside the range of electronic addresses assigned to the manufacturer of the turnover controller 2; (e) an approval of the registration of the turnover controller 2 on the server 1, in case that a position of the turnover controller 2 is different from a position of a distribution location for less than a predefined number; (f) a disapproval of the registration of the turnover controller 2 on the server 1, in case that the position of the turnover controller 2 is different from the position of the distribution location for more than a predefined number; (g) an approval of the registration of the turnover controller 2 on the server 1, in case of valid authentication code of a tax payer; (h) a disapproval of the registration of the turnover controller 2 on the server 1, in case of invalid authentication code of the tax payer; (i) an approval of the registration of the turnover controller 2 on the server 1, in case that an electronic address of the turnover controller 2 is within the range of electronic addresses assigned to the tax payer; (j) a disapproval of the registration of the turnover controller 2 on the server 1, in case that an electronic address of the turnover controller 2 is outside the range of electronic addresses assigned to the tax payer; (k) an approval of the registration of the turnover controller 2 on the server 1, in case that a position of the turnover controller 2 is different from a position of a sale location for less than a predefined number; and (l) a disapproval of the registration of the turnover controller 2 on the server 1, in case that the position of the turnover controller 2 is different from the position of the sale location for more than a predefined number.

The data of the turnover controller 2 can comprise at least one type of record in the PLU memory 14 selected from a group of types of records comprising: (a) PLU code; (b) PLU name; (c) tax rate assigned to PLU; (d) name of PLU metric unit; and (e) price of PLU metric unit.

The data of the turnover controller 2 can comprise at least one type of record in the transaction memory 15 selected from a group of types of records comprising: (a) serial number of a fiscal receipt, date and time of forming that fiscal receipt; (b) individual recorded transactions; (c) individual cancelled recorded transactions; (d) serial number of a refunded receipt, date and time of forming that refunded receipt; (e) individual refunded transactions; (f) individual cancelled refunded transactions; (g) payment amounts per each payment means; (h) identification number of the turnover controller of a buyer; and (i) identification number of a buyer.

A transaction can comprise at least one type of record selected from a group of types of records comprising: (a) PLU code; (b) PLU name; (c) tax rate assigned to PLU; (d) name of PLU metric unit; (e) price of PLU metric unit; (f) PLU quantity; (g) purchased PLU as transaction type; (h) sold PLU as transaction type; (i) returned PLU as transaction type; (j) stored PLU as transaction type; (k) eliminated PLU as transaction type; and (l) stolen PLU as transaction type.

The data of the turnover controller 2 can comprise at least one type of record in the turnover memory 16 selected from a group of types of records comprising: (a) serial number of last fiscal receipt before forming daily report; (b) summary recorded turnover per each tax rate; (c) total summary recorded turnover for all tax rates; (d) summary canceled recorded turnover per each tax rate; (e) total summary canceled recorded turnover for all tax rates; (f) difference between summary recorded turnover and summary canceled recorded turnover per each tax rate; (g) difference between summary recorded turnover and summary canceled recorded turnover for all tax rates; (h) serial number of last refunded receipt before forming daily report; (i) summary refunded turnover per each tax rate; (j) total summary refunded turnover for all tax rates; (k) summary canceled refunded turnover per each tax rate; (l) total summary canceled refunded turnover for all tax rates; (m) difference between summary refunded turnover and summary canceled refunded turnover per each tax rate; (n) difference between summary refunded turnover and summary canceled refunded turnover for all tax rates; (o) serial number of daily report, date and time of forming daily report; and (p) payment amounts per each payment means, selected from a group comprising: cash, payment cards, checks and money transfer between bank accounts.

The step for providing data security can comprise at least one step selected from a group of steps comprising: (a) management of the first opening controller 7; (b) management of the second opening controller 8; (c) management of the program memory 11; (d) management of the operating memory 12; (e) management of the log memory 13; (f) management of the PLU memory 14; (g) management of the transaction memory 15; (h) management of the turnover memory 16; (i) prevention of turnover registration; (j) protection of serial number counters; (k) management of the display 21; and (l) management of the printer 22.

The step of the management of the first opening controller 7 can comprise at least one step selected from a group of steps comprising: (a) storing of a type of the authorization for opening of the first enclosure 5 in the log memory 13; (b) storing date and time of the opening of the first enclosure 5 in the log memory 13; (c) storing date and time of the closing of the first enclosure 5 in the log memory 13; (d) disabling further turnover registration using the turnover controller 2 in case of unauthorized opening of the first enclosure 5; (e) disabling opening of the first enclosure 5; and (f) free opening of the first enclosure 5.

The step of the management of the second opening controller 8 can comprise at least one step selected from a group of steps comprising: (a) storing of a type of the authorization for opening of the second enclosure 6 in the log memory 13; (b) storing date and time of the opening of the second enclosure 6 in the log memory 13; (c) storing date and time of the closing of the second enclosure 6 in the log memory 13; (d) disabling further turnover registration using the turnover controller 2 in case of unauthorized opening of the second enclosure 6; (e) disabling opening of the second enclosure 6; and (f) free opening of the second enclosure 6.

The step of the management of the program memory 11 can comprise at least one step selected from a group of steps comprising: (a) retention in the program memory 11 a program independently from the power supply; (b) storing in the program memory 11 a complete program with update capability; (c) storing in a first part of the program memory 11 basic program without update capability, which serves for registering the turnover controller 2 to the server 1 and update of additional programs; (d) storing in a second part of the program memory 11 additional programs with update capability; (e) protection of the program memory 11 from change or clear; (f) protection of the program memory 11 from change or clear, unless it is requested by a command for receiving a program file from the server 1; (g) protection of the first part of the program memory 11 from change or clear; and (h) protection of the second part of the program memory 11 from change or clear, unless it is requested by the command for receiving the program file from the server 1.

The step of the management of the operating memory 12 can comprise at least one step selected from a group of steps comprising: (a) retention in the operating memory 12 data independently from the power supply; (b) storing in the operating memory 12 program variables; (c) protection of the operating memory 12 from clear; and (d) protection of the operating memory 12 from clear, unless it is requested after reset.

The step of the management of the log memory 13 can comprise at least one step selected from a group of steps comprising: (a) retention in the log memory 13 data independently from the power supply; (b) protection of the log memory 13 from change of data; (c) protection of the log memory 13 from clear of data; and (d) protection of the log memory 13 from clear of data that are not sent to the server 1.

The step of the management of the PLU memory 14 can comprise at least one step selected from a group of steps comprising: (a) retention in the PLU memory 14 data independently from the power supply; (b) protection of the PLU memory 14 from clear of data; and (c) protection of the PLU memory 14 from clear of data, unless it is requested by commands for PLU base handling from the other server.

The step of the management of the transaction memory 15 can comprise at least one step selected from a group of steps comprising: (a) retention in the transaction memory 15 data independently from the power supply; (b) protection of the transaction memory 15 from change of data; (c) protection of the transaction memory 15 from clear of data; and (d) protection of the transaction memory 15 from clear of data that are not sent to the server 1.

The step of the management of the turnover memory 16 can comprise at least one step selected from a group of steps comprising: (a) retention in the turnover memory 16 data independently from the power supply; (b) protection of the turnover memory 16 from change of data; (c) protection of the turnover memory 16 from clear of data; and (d) protection of the turnover memory 16 from clear of data that are not sent to the server 1.

The step of the prevention of turnover registration can comprise prevention of turnover registration because of at least one error selected from a group of errors.

At least one serial number counter can be selected from a group of counters comprising: (a) serial number counter of data records in the log memory 13; (b) serial number counter of data records in the transaction memory 15; and (c) serial number counter of data records in the turnover memory 16.

The step of the management of the display 21 can comprise prevention of direct displaying of messages from at least one interface.

The step of the management of the printer 22 can comprise at least one step selected from a group of steps comprising: (a) continuation of printing until the end of line during power down; (b) continuation of temporarily stopped printing after power up; (c) continuation of temporarily stopped printing after printer malfunction and servicing; (d) prevention of printing of documents before registration of the turnover controller 2 on the server 1; (e) prevention of printing of documents after deregistration of the turnover controller 2 on the server 1; (f) prevention of printing of non-fiscal documents with names and prices of goods and services and turnovers from fiscal documents; (g) printing of a fiscal logo only on fiscal documents; (h) prevention of printing of non-fiscal documents with symbols similar to the fiscal logo; and (i) prevention of direct printing of messages from at least one interface.

The step of data exchange between the turnover controller 2 and the server 1 can comprise at least one step selected from a group of steps comprising: (a) utilization of a communication protocol; (b) data authentication; (c) data encryption; (d) data decryption; (e) definition of access rights; (f) generation of a request for calling the server 1; (g) selection of data for sending to the server 1; (h) selection of data for receiving from the server 1; (i) creation of a filename of a file for sending to the server 1; (j) creation of a filename of a file for receiving from the server 1; (k) sending data to the server 1; (l) receiving data from the server 1; (m) synchronizing date and time of the turnover controller 2 with date and time of the server 1; and (n) data exchange between the turnover controller 2 and other servers.

The step of the utilization of communication protocol can comprise at least one method selected from a group of methods comprising: (a) Pretty Good Privacy (PGP); (b) Secure Shell (SSH); (c) Security Socket Layer (SSL); (d) Transport Layer Security (TSL); (e) IP Security (IPsec); (f) HyperText Transmission Protocol (HTTP); (g) File Transfer Protocol (FTP); (h) Secure HyperText Transmission Protocol (SHTTP); (i) Secure File Transfer Protocol (SFTP); and (j) Secure Electronic Transaction (SET).

The step of data authentication can comprise at least one method selected from a group of methods comprising: (a) Message Digest (MD5); (b) Secure Hash Algorithm (SHA); (c) Keyed Hash Message Authentication Code (HMAC); (d) Direct Digital Signature; (e) Arbitrary Digital Signature; (f) Digital Signature Standard (DSS); (g) Mutual Authentication; (h) Authentication with Public Key; (i) Kerberos; (j) X.509; and (k) Zero Knowledge Proof.

At least one step of data encryption and data decryption steps can comprise at least one method selected from a group of methods comprising: (a) Rivest Shamir Adelman (RSA); (b) Data Encryption Standard (DES); (c) Triple-Pass DES (EDE); (d) Triple DES (3DES); (e) RC2; (f) RC4; (g) RC6; (h) Rijndmael alias Advanced Encryption Standard (AES); (i) International Data Encryption Algorithm (IDEA); (j) Diffie-Hellman; (k) El Gamal; (l) Blowfish; (m) One-time-pad; (n) Substitution; (o) Permutation; and (p) Garbage-in-between.

The step of the definition of access rights can comprise at least one step selected from a group of steps comprising: (a) definition of access rights to a network with the server 1; (b) definition of an address of the server 1 in said network; (c) definition of access rights to the server 1; (d) definition of folder name in the server 1 for receiving log files; (e) definition of folder name in the server 1 for receiving transaction files; (f) definition of folder name in the server 1 for receiving turnover files; (g) definition of folder name in the server 1 for storing command files; and (h) definition of folder name in the server 1 for storing program files.

The step of the generation of a request for calling the server 1 can comprise at least one step selected from a group of steps comprising: (a) automatic generation of the request for calling the server 1 on the basis of commands; (b) generation of the request for calling the server 1 by polling the turnover controller 2; (c) generation of the request for calling the server 1 on the basis of received call; (d) generation of the request for calling the server 1 on the basis of received SMS message; and (e) generation of the request for calling the server 1 on the basis of received e-mail.

The selected data for sending to the server 1 can comprise at least one record selected from a group of records comprising: (a) records from the log memory 13 for a log file; (b) records from the transaction memory 15 for a transaction file; and (c) records from the turnover memory 16 for a turnover file.

The selected data for receiving from the server 1 can comprise at least one record selected from a group of records comprising: (a) commands for a command file; and (b) program for a program file.

A filename of a file for sending to the server 1 can comprise an identification number of the turnover controller 2 and a partial filename selected from a group of partial filenames comprising: (a) partial log filename for a log file; (b) partial transaction filename for a transaction file; and (c) partial turnover filename for a turnover file.

A filename of a file for receiving from the server 1 can comprise an identification number of the turnover controller 2 and a partial filename selected from a group of partial filenames comprising: (a) partial command filename for a command file; and (b) partial program filename for a program file.

The step of sending data to the server 1 can comprise steps of: (a) sending to the server 1 a file selected from a group of files comprising: a log file, a transaction file and a turnover file; (b) receiving an acknowledge from the server 1; (c) checking correctness of the file received by the server 1 using the received acknowledge; and (d) performing steps a) through d) at most predefined number of tries per day in predefined time intervals, in case of receiving incorrect file by the server 1.

The step of sending data to the server 1 can further comprise at least one of the steps selected from a group of steps comprising: (a) activating first visual indication within the predefined time interval before sending a file; (b) deactivating first visual indication and activating second visual indication during creating of the file; (c) deactivating second visual indication and activating third visual indication after the file was created; and (d) deactivating third visual indication after receiving correct file by the server 1.

The step of receiving file can comprise steps of: (a) receiving from the server 1 a file selected from a group of files comprising: a command file and a program file; (b) checking correctness of received file and correctness of a filename of received file; (c) performing steps a) through c) at most predefined number of tries per day in predefined time intervals, in case of receiving incorrect file or incorrect filename; (d) rejecting incorrect received file and continuing use of current file; and (e) starting use of correct received file instead of current file.

The step of receiving file can comprise steps of: (a) receiving file signature from the server 1; (b) comparing received file signature with current file signature; (c) skipping all steps d) through i), in case that current file signature is identical to received file signature; (d) performing steps e) through i) in case that current file signature is different from received file signature; (e) receiving a file from the server 1 selected from a group of files comprising: a command file and a program file; (f) checking correctness of received file and correctness of a filename of received file; (g) performing steps e) through g) at most predefined number of tries per day in predefined time intervals, in case of receiving incorrect file or incorrect filename; (h) rejecting incorrect received file and continuing use of current file instead; and (i) starting use of correct received file instead of current file.

The step of synchronizing date and time of the turnover controller 2 with date and time of the server 1 can comprise at least one step selected from a group of steps comprising: (a) synchronization of a real-time clock 17 of the turnover controller 2 with a real-time clock of the server 1 using NTP (Network Time Protocol), based on time synchronization command; and (b) automatic switch between summer and winter time, according to the appropriate legislation.

The step of data exchange between the turnover controller 2 and other servers can comprise at least one step selected from a group of steps comprising: (a) receiving from a second server PLU base, which for each PLU comprises: PLU code, PLU name, tax rate assigned to PLU, name of PLU metric unit and price of PLU metric unit; (b) receiving from the second server a file for adding selected PLU in PLU base; (c) receiving from the second server a file for clearing selected PLU in PLU base; (d) receiving from the second server a file for updating selected PLU in PLU base; (e) receiving from the second server a file for updating prices of PLU metric unit of selected PLU in PLU base; (f) sending to the second server a complete PLU base; (g) sending to the second server a list of sold PLU; (h) sending to the second server a list of unsold PLU; (i) sending to the second server a list of refunded PLU; (j) sending to a third server a request for recharging prepaid SIM card; (k) receiving from the third server a pin code for recharging prepaid SIM card and printing of received pin code on the printer 22; (l) receiving from the third server a pin code for recharging prepaid SIM card and printing of received pin code on an additional printer; (m) sending to a fourth server lottery digits; (n) receiving from the fourth server a lottery confirmation code and its printing on the printer 22; (o) receiving from the fourth server a lottery confirmation code and its printing on the additional printer; (p) receiving from a fifth server advertising messages for showing on the display 21; (q) receiving from the fifth server time schedule for showing messages on the display 21; (r) receiving from a sixth server advertising messages for showing on the seller's display 24; (s) receiving from the sixth server time schedule for showing messages on the seller's display 24; (t) receiving from a seventh server advertising messages for showing on an additional monitor; (u) receiving from the seventh server time schedule for showing messages on the additional monitor; (v) sending to an eight server data from payment card readers; (w) receiving from the eight server data for payment card readers; (x) sending to a ninth server data from an intruder alarm detector; (y) sending to the ninth server video data from a surveillance camera; (z) sending to the ninth server audio data from a microphone; and (aa) sending to a tenth server data from fire alarm detector.

The step of registering the turnover controller 2 on the server 1 can comprise steps of: (a) entering an authentication code of the manufacturer of the turnover controller 2 into the turnover controller 2; (b) sending to the server 1 of the authentication code of the manufacturer of the turnover controller 2; (c) receiving a disapproval of the registration of the turnover controller 2 on the server 1, in case of invalid authentication code of the manufacturer of the turnover controller 2; and (d) receiving an identification number of the turnover controller 2 on the server 1 and its writing into the turnover controller 2, in case of valid authentication code of the manufacturer of the turnover controller 2.

The step of registering the turnover controller 2 on the server 1 can comprise steps of: (a) sending a range of electronic addresses assigned to the manufacturer of the turnover controller 2 to the server 1 from the telecommunication operator; (b) receiving a disapproval of the registration of the turnover controller 2 on the server 1, in case that an electronic address of the turnover controller 2 is outside the range of electronic addresses assigned to the manufacturer of the turnover controller 2; and (c) receiving an approval of the registration of the turnover controller 2 on the server 1, in case that the electronic address of the turnover controller 2 is within the range of electronic addresses assigned to the manufacturer of the turnover controller 2.

The step of registering the turnover controller 2 on the server 1 can comprise steps of: (a) sending a position of a distribution location to the server 1 from the telecommunication operator; (b) writing the distribution location into the turnover controller 2; (c) sending a log file to the server 1; (d) sending a position of the turnover controller 2 to the server 1 from the telecommunication operator; (e) receiving a disapproval of the registration of the turnover controller 2 on the server 1, in case that the position of the turnover controller 2 is different from the position of the distribution location for more than a predefined number; and (f) receiving an approval of the registration of the turnover controller 2 on the server 1, in case that the position of the turnover controller 2 is different from the position of the distribution location for less than a predefined number.

The step of registering the turnover controller 2 on the server 1 can comprise steps of: (a) sending to the server 1 a list of parts assembled into the turnover controller 2, comprising: a production number of a part, a secret key for that part in case of a symmetric encryption, or a public key for that part in case of an asymmetric encryption; (b) sending a log file to the server 1; (c) receiving a disapproval of the registration of the turnover controller 2 on the server 1, in case that the production number of at least one part of the turnover controller 2 is not on the list of parts assembled in the turnover controller 2; and (d) receiving an approval of the registration of the turnover controller 2 on the server 1, in case that the production numbers of all parts of the turnover controller 2 are on the list of parts assembled in the turnover controller 2.

The step of registering the turnover controller 2 on the server 1 can comprise steps of: (a) sending to the server 1 a list of parts assembled into the turnover controller 2, comprising: a production number of a part, a secret key for that part in case of a symmetric encryption, or a public key for that part in case of an asymmetric encryption; (b) sending a log file to the server 1; (c) receiving a disapproval of the registration of the turnover controller 2 on the server 1, in case that a communication with at least one part of the turnover controller 2 cannot be performed with the key for that part from the list of parts assembled in the turnover controller 2; and (d) receiving an approval of the registration of the turnover controller 2 on the server 1, in case that a communication with each part of the turnover controller 2 can be performed with the key for that part from the list of parts assembled in the turnover controller 2.

The step of registering the turnover controller 2 on the server 1 can comprise steps of: (a) entering an authentication code of the manufacturer of the turnover controller 2 into the turnover controller 2 and its storing in the log memory 13; (b) sending a log file to the server 1; (c) receiving an acknowledge from the server 1; (d) checking correctness of the log file received by the server 1 using the received acknowledge from the server 1; (e) performing steps b) through e) at most predefined number of tries per day in predefined time intervals, in case of receiving incorrect log file by the server 1; (f) receiving a command file from the server 1 in case of receiving correct log file by the server 1; (g) checking correctness of received command file and correctness of a filename of received command file; (h) performing steps f) through h) at most predefined number of tries per day in predefined time intervals, in case of receiving incorrect command file or incorrect command filename; (i) rejecting received incorrect command file and continuing use of current command file; (j) starting use of received correct command file instead of current command file; (k) extracting a disapproval of the registration of the turnover controller 2 on the server 1, in case of invalid authentication code of the manufacturer of the turnover controller 2; and (l) extracting an approval of the registration of the turnover controller 2 on the server 1 and the identification number of the turnover controller 2 from received correct command file and its storing in the log memory 13, in case of valid authentication code of the manufacturer of the turnover controller 2.

The step of registering the turnover controller 2 on the server 1 can comprise steps of: (a) entering an authentication code of a tax payer into the turnover controller 2; (b) sending to the server 1 of the authentication code of the tax payer; (c) receiving a disapproval of the registration of the turnover controller 2 on the server 1, in case of invalid authentication code of the tax payer; and (d) receiving an identification number of the turnover controller 2 from the server 1 and its writing into the turnover controller 2, in case of valid authentication code of the tax payer.

The step of registering the turnover controller 2 on the server 1 can comprise steps of: (a) sending a range of electronic addresses assigned to a tax payer to the server 1 from the telecommunication operator; (b) receiving a disapproval of the registration of the turnover controller 2 on the server 1, in case that an electronic address of the turnover controller 2 is outside the range of electronic addresses assigned to the tax payer; and (c) receiving an approval of the registration of the turnover controller 2 on the server 1, in case that the electronic address of the turnover controller 2 is within the range of electronic addresses assigned to the tax payer.

The step of registering the turnover controller 2 on the server 1 can comprise steps of: (a) sending a position of a sale location to the server 1 from the telecommunication operator; (b) writing the sale location into the turnover controller 2; (c) sending a log file to the server 1; (d) sending a position of the turnover controller 2 to the server 1 from the telecommunication operator; (e) receiving a disapproval of the registration of the turnover controller 2 on the server 1, in case that the position of the turnover controller 2 is different from the position of the sale location for more than a predefined number; and (f) receiving an approval of the registration of the turnover controller 2 on the server 1, in case that the position of the turnover controller 2 is different from the position of the sale location for less than a predefined number.

The step of registering the turnover controller 2 on the server 1 can comprise steps of: (a) entering an authentication code of a tax payer into the turnover controller 2 and its storing in the log memory 13; (b) sending a log file to the server 1; (c) receiving an acknowledge from the server 1; (d) checking correctness of the log file received by the server 1 using the received acknowledge from the server 1; (e) performing steps b) through e) at most predefined number of tries per day in predefined time intervals, in case of receiving incorrect log file by the server 1; (f) receiving a command file from the server 1 in case of receiving correct log file by the server 1; (g) checking correctness of received command file and correctness of a filename of received command file; (h) performing steps f) through h) at most predefined number of tries per day in predefined time intervals, in ease of receiving incorrect command file or incorrect command filename; (i) rejecting received incorrect command file and continuing use of current command file; (j) starting use of received correct command file instead of current command file; (k) extracting a disapproval of the registration of the turnover controller 2 on the server 1, in case of invalid authentication code of tax payer; and (l) extracting an approval of the registration of the turnover controller 2 on the server 1 and an identification number of the tax payer from received correct command file and its storing in the log memory 13, in case of valid authentication code of the tax payer.

The step of turnover registration can comprise steps of: (a) receiving key codes; (b) parsing received key codes; (c) rejecting incorrect key code sequences; (d) executing correct key code sequences; and (e) repeating steps a) through e) until receiving stop key code.

The step of executing correct key code sequences can comprise at least one step selected from a group of steps comprising: (a) entering individual recorded transactions; (b) entering individual canceled recorded transactions; (c) entering individual refunded transactions; (d) entering individual canceled refunded transactions; (e) summing turnovers from individual recorded transactions per each tax rate; (f) summing turnovers from individual recorded transactions for all tax rates; (g) summing turnovers from individual canceled recorded transactions per each tax rate; (h) summing turnovers from individual canceled recorded transactions for all tax rates; (i) summing turnovers from individual recorded transactions per each tax rate and subtracting turnovers from individual canceled recorded transactions per each tax rate; (i) summing turnovers from individual recorded transactions for all tax rates and subtracting turnovers from individual canceled recorded transactions for all tax rates; (k) summing turnovers from individual refunded transactions per each tax rate; (l) summing turnovers from individual refunded transactions for all tax rates; (m) summing turnovers from individual canceled refunded transactions per each tax rate; (n) summing turnovers from individual canceled refunded transactions for all tax rates; (o) summing turnovers from individual refunded transactions per each tax rate and subtracting turnovers from individual canceled refunded transactions per each tax rate; (p) summing turnovers from individual refunded transactions for all tax rates and subtracting turnovers from individual canceled refunded transaction for all tax rates; (q) presenting records from a memory selected from a group of memories, comprising: the program memory 11, the operating memory 12, the log memory 13, the PLU memory 14, the transaction memory 15 and the turnover memory 16; (r) entering into the transaction memory 15 the amount of cash in deposited by a cashier; (s) entering into the transaction memory 15 the amount of cash out withdrawn by a cashier; (t) entering into the transaction memory 15 payment means per each type of payment means; and (u) presenting records from a memory.

The step of presenting records from a memory can comprise at least one step selected from a group of steps comprising: (a) displaying records on the display 21; (b) displaying records on the seller's display 24; (c) printing records on the printer 22; and (d) playing audio records.

The step of executing correct key code sequence can comprise at least one step selected from a group of steps comprising: (a) writing of a complete PLU base in the PLU memory 14; (b) adding selected PLU in the PLU base in the PLU memory 14; (c) clearing selected PLU in PLU base in the PLU memory 14; (d) updating selected PLU in PLU base in the PLU memory 14; (e) updating price of a metric unit of selected PLU in PLU base in the PLU memory 14; (f) reading the complete PLU base from the PLU memory 14; (g) reading a list of sold PLU from the PLU memory 14; (h) reading a list of unsold PLU from the PLU memory 14; and (i) reading a list of refunded PLU from the PLU memory 14.

The step of deregistering the turnover controller 2 on the server 1 can comprise steps of: (a) entering an authentication code of a tax payer into the turnover controller 2; (b) sending to the server 1 of the authentication code of the tax payer; (c) receiving a disapproval of the deregistration of the turnover controller 2 on the server 1, in case of invalid authentication code of the tax payer; and (d) receiving predefined identification number of the turnover controller 2 on the server 1 and its writing into the turnover controller 2, in case of valid authentication code of the tax payer.

The step of deregistering the turnover controller 2 on the server 1 can comprise steps of: (a) sending a range of electronic addresses assigned to a tax payer to the server 1 from the telecommunication operator; (b) receiving a disapproval of the deregistration of the turnover controller 2 on the server 1, in case that an electronic address of the turnover controller 2 is outside the range of electronic addresses assigned to a tax payer; and (c) receiving an approval of the deregistration of the turnover controller 2 on the server 1, in case that the electronic address of the turnover controller 2 is within the range of electronic addresses assigned to the tax payer.

The step of deregistering the turnover controller 2 on the server 1 can comprise steps of: (a) sending a position of a sale location to the server 1 from the telecommunication operator; (b) writing the sale location into the turnover controller 2; (c) sending a log file to the server 1; (d) sending a position of the turnover controller 2 to the server 1 from the telecommunication operator; (e) receiving a disapproval of the deregistration of the turnover controller 2 on the server 1, in case that the position of the turnover controller 2 is different from the position of the sale location for more than a predefined number; and (f) receiving an approval of the deregistration of the turnover controller 2 on the server 1, in case that the position of the turnover controller 2 is different from the position of the sale location for less than a predefined number.

The step of deregistering the turnover controller 2 on the server 1 can comprise steps of: (a) entering an authentication code of a tax payer into the turnover controller 2 and its storing in the log memory 13; (b) sending a log file to the server 1; (c) receiving an acknowledge from the server 1; (d) checking correctness of the log file received by the server 1 using the received acknowledge from the server 1; (e) performing steps b) through e) at most predefined number of tries per day in predefined time intervals, in case of receiving incorrect tog file by the server 1; (f) receiving a command file from the server 1 in case of receiving correct log file by the server 1; (g) checking correctness of received command file and correctness of a filename of received command file; (h) performing steps f) through h) at most predefined number of tries per day in predefined time intervals, in case of receiving incorrect command file or incorrect command filename; (i) rejecting received incorrect command file and continuing use of current command file; (j) starting use of received correct command file instead of current command file; (k) extracting a disapproval of the deregistration of the turnover controller 2 on the server 1, in case of invalid authentication code of tax payer; and (l) extracting an approval of the deregistration of the turnover controller 2 on the server 1 and predefined identification number of tax payer from received correct command file and its storing in the log memory 13, in case of valid authentication code of tax payer.

The step of deregistering the turnover controller 2 on the server 1 can comprise steps of: (a) entering an authentication code of the manufacturer of the turnover controller 2 into the turnover controller 2; (b) sending to the server 1 of the authentication code of the manufacturer of the turnover controller 2; (c) receiving a disapproval of the deregistration of the turnover controller 2 on the server 1, in case of invalid authentication code of the manufacturer of the turnover controller 2; and (d) receiving predefined identification number of the turnover controller 2 on the server 1 and its writing into the turnover controller 2, in case of valid authentication code of the manufacturer of the turnover controller 2.

The step of deregistering the turnover controller 2 on the server 1 can comprise steps of: (a) sending a range of electronic addresses assigned to the manufacturer of the turnover controller 2 to the server 1 from the telecommunication operator; (b) receiving a disapproval of the deregistration of the turnover controller 2 on the server 1, in case that an electronic address of the turnover controller 2 is outside the range of electronic addresses assigned to the manufacturer of the turnover controller 2; and (c) receiving an approval of the deregistration of the turnover controller 2 on the server 1, in case that the electronic address of the turnover controller 2 is within the range of electronic addresses assigned to the manufacturer of the turnover controller 2.

The step of deregistering the turnover controller 2 on the server 1 can comprise steps of: (a) sending a position of a distribution location to the server 1 from the telecommunication operator; (b) writing the distribution location into the turnover controller 2; (c) sending a log file to the server 1; (d) sending a position of the turnover controller 2 to the server 1 from the telecommunication operator; (e) receiving a disapproval of the deregistration of the turnover controller 2 on the server 1, in case that the position of the turnover controller 2 is different from the position of the distribution location for more than a predefined number; and (f) receiving an approval of the deregistration of the turnover controller 2 on the server 1, in case that the position of the turnover controller 2 is different from the position of the distribution location for less than a predefined number.

The step of deregistering the turnover controller 2 on the server 1 can comprise steps of: (a) sending a log file to the server 1; (b) receiving a disapproval of the deregistration of the turnover controller 2 on the server 1, in case that a production number of at least one part of the turnover controller 2 is not on a list of parts assembled in the turnover controller 2; and (c) receiving an approval of the deregistration of the turnover controller 2 on the server 1, in case that the production number of each part of the turnover controller 2 is on the list of parts assembled in the turnover controller 2.

The step of deregistering the turnover controller 2 on the server 1 can comprise steps of: (a) sending a log file to the server 1; (b) receiving a disapproval of the deregistration of the turnover controller 2 on the server 1, in case that a communication with at least one part of the turnover controller 2 cannot be performed with the key for that part from a list of parts assembled in the turnover controller 2; and (c) receiving an approval of the deregistration of the turnover controller 2 on the server 1, in case that a communication with each part of the turnover controller 2 can be performed with the key for that part from the list of parts assembled in the turnover controller 2.

The step of deregistering the turnover controller 2 on the server 1 can comprise steps of: (a) entering an authentication code of the manufacturer of the turnover controller 2 into the turnover controller 2 and its storing in the log memory 13; (b) sending a log file to the server 1; (c) receiving an acknowledge from the server 1; (d) checking correctness of the log file received by the server 1 using the received acknowledge from the server 1; (e) performing steps b) through e) at most predefined number of tries per day in predefined time intervals, in case of receiving incorrect log file by the server 1; (f) receiving a command file from the server 1 in case of receiving correct log file by the server 1; (g) checking correctness of received command file and correctness of a filename of received command file; (h) performing steps f) through h) at most predefined number of tries per day in predefined time intervals, in case of receiving incorrect command file or incorrect command filename; (i) rejecting received incorrect command file and continuing use of current command file; (j) starting use of received correct command file instead of current command file; (k) extracting a disapproval of the deregistration of the turnover controller 2 on the server 1, in case of invalid authentication code of the manufacturer of the turnover controller 2; and (l) extracting an approval of the deregistration of the turnover controller 2 on the server 1 and the predefined identification number of the turnover controller 2 from received correct command file and its storing in the log memory 13, in case of valid authentication code of the manufacturer of the turnover controller 2.

The step of self-testing can comprise at least one step selected from a group of steps comprising: (a) checking data exchange between parts from the first set of parts 3 and parts from the second set of parts 4 of the turnover controller 2; (b) checking the communication between the turnover controller 2 and the server 1; (c) entering key codes for requesting a type of self-test using at least one interface listed in claim 11; (d) comparing obtained self-test results with expected self-test results stored within program in the program memory 11; (e) sending obtained self-test results to the server 1; (f) comparing received self-test results on the server 1 with expected self-test results store on the server 1; and (g) presenting self-test results.

The step of data exchange between a turnover controller of a seller and a turnover controller of a buyer can exchange at least data selected from a group of data comprising: (a) identification number of the turnover controller of a seller; (b) identification number of a seller; (c) identification number of the turnover controller of a buyer; (d) identification number of a buyer; (e) name and address of seller's headquarters, date and time of entering name and address of seller's headquarters; (f) name and address of sale location, date and time of entering name and address of sale location; (g) serial number of fiscal receipt, date and time of forming fiscal receipt; (h) individual recorded transactions; (i) individual cancelled recorded transactions; (j) serial number of refunded receipt, date and time of forming refunded receipt; (k) individual refunded transactions; (l) individual canceled refunded transactions; and (m) payment amounts per each payment means.

The step of data exchange between a turnover controller of a seller and a turnover controller of a buyer can comprise at least one step selected from a group of steps comprising: (a) data exchange through the server 1; (b) data exchange through other servers; and (c) direct data exchange between turnover controllers.

The step of servicing can comprise at least one step selected from a group of steps comprising: (a) entering into the turnover controller 2 records about service, comprising: type of service, date and time of the beginning and end of service; (b) deregistering removed parts of the turnover controller 2 on the server 1; and (c) registering new parts of the turnover controller 2 on the server 1.

The final goal of this disclosure is to reduce all possible misuses during turnover registration solely to the absence of turnover registration, in other words, non-entering data about sold goods and services in the turnover controller 2, independently of future advances in technology and independently of future changes of legal regulations in national legislations, thus enabling unique and simple certification of the turnover controller 2 in many states, mass production of cheap turnover controllers 2 and their utilization not only in the states with fiscal cash registers and POS systems with fiscal printers, but also in the states with non-fiscal cash registers and POS systems with non-fiscal printers.

It should be emphasized that the absence of turnover registration can be later detected using risk analysis methods based on data from the server 1, which are well known to audit experts in tax administrations, and which are not the object of this disclosure. This provides fast and simple training of tax inspectors for audit of turnover controllers 2, contrary to specialized, highly sophisticated, complex, long term and expensive training of tax inspectors for audit of non-fiscal cash registers, fiscal cash registers, PC and POS systems, which not only covers the configuration (“programming”) devices, but also expertise related to the authenticity of hardware, program and data, and in a case of POS systems, even reconstruction of deleted data from a hard disk.

The requirement that all distributors use this solution can prevent diversion and infiltration of goods by controlling every link in distribution channels, no matter how diverse and complex they are and at same time facilitate law enforcement against those operating outside of it, while promoting free movement of goods. The application of this disclosure provides increase of revenues of governments and companies by reduction of smuggling, bootlegging and a minimization of customs, tax and excise duties evasion, without imposing undue burdens on manufacturers, exporters, importers, wholesalers, retailers, while keeping privacy of end-users.

Although the preferred embodiments of the present disclosure are described and illustrated, those skilled in the art can perform various modifications and design equivalents of this disclosure. According to the above description, the present disclosure is intended to cover all such modifications and equivalents within the scope of the following claims.

1. A turnover controller (2) for controlling turnover comprising:
a) a first set of parts (3) comprising: a microprocessor (10), a program memory (11), an operating memory (12), a log memory (13), a PLU (Price Look-Up) memory with data about goods and services (14), a transaction memory (15), a turnover memory (16), a real-time clock (17), a backup battery (18) for supplying at least one part of the turnover controller (2); and
b) a second set of parts (4) comprising: a keyboard (20), a display (21), a printer (22);
wherein:
the first set of parts (3) is assembled in a first enclosure (5), which opening is controlled by a first opening controller (7);
parts from the second set of parts (4) are assembled in at least one second enclosure (6), which opening is controlled by at least one second opening controller (8); and
the first set of parts (3) and the second set of parts (4) are connected in order to enable turnover control.

2. The turnover controller of claim 1, wherein the first enclosure (5) is assembled inside the second enclosure (6).

3. The turnover controller of claim 1, which additionally comprises at least one part selected from a group of parts comprising:
a) a communication device (19);
b) a power supply (23);
c) a seller's display (24);
d) wired port (25);
e) wireless port (26);
f) antenna (27);
g) SIM card (28); and
h) microprocessor supervisor (9).

4. The turnover controller of claim 3, wherein the communication device (19) is assembled in the first enclosure (5).

5. The turnover controller of claim 3, wherein the communication device (19) is assembled in the second enclosure (6).

6. The turnover controller of claim 1, wherein the first set of parts (3) is connected with the second set of parts (4) using at least one cable, which disconnection is controlled by at least one means selected from a group of means comprising:
a) the first opening controller (7); and
b) at least one second opening controller (8).

7. The turnover controller of claim 1, wherein at least one part of the second set of parts (4) additionally comprises a microcontroller which supports data encryption and decryption for interfacing with the first set of parts (3).

8. The turnover controller of claim 1, wherein at least two memories from the following memories: the program memory (11), the operating memory (12), the log memory (13), the PLU (Price Look-Up) memory (14), the transaction memory (15) and the turnover memory (16) are realized inside common integrated circuit.

9. The turnover controller of claim 1, wherein the communication device (19) is selected from a group of communication devices comprising:
wireless communication device;
b) mobile phone;
c) GPRS (General Packet Radio Service) communication device;
d) EDGE (Enhanced Data rates for GSM Evolution) communication device;
e) UMTS/3G (Universal Mobile Telecommunications System) communication device;
f) UMTS/4G (Universal Mobile Telecommunications System) communication device;
g) CDMA 2000 (Code Division Multiplex Access) communication device;
h) HSDPA (High Speed Downlink Packet Access) communication device;
i) WiMAX (IEEE 802.16) communication device;
j) WiFi (IEEE 802.11) communication device;
k) satellite communication device;
l) wired communication device;
m) POTS (Plain Old Telephone Service) communication device;
n) ISDN (Integrated Services Digital Network) communication device;
o) ADSL/ADSL+(Asymmetric Digital Subscriber Line) communication device;
p) ADSL2/ADSL2+(Asymmetric Digital Subscriber Line 2) communication device;
q) HDSL (High Data Rate Digital Subscriber Line) communication device;
r) SDSL (Symmetric Digital Subscriber Line) communication device;
s) RADSL (Rate-Adaptive Digital Subscriber Line) communication device;
t) VDSL (Very High Speed Digital Subscriber Line) communication device;
u) VDSL 2 (Very High Speed Digital Subscriber Line 2) communication device;
v) G.SHDSL (Symmetric High-Speed Digital Subscriber Line) communication device;
w) PDSL (Powerline Digital Subscriber Line) communication device;
x) UDSL (Uni Digital Subscriber Line) communication device;
y) cable communication device; and
z) communication part of any communication device.

10. The turnover controller of claim 1, wherein at least one controller of: the first opening controller (7) and at least one second opening controller (8), comprises means for access control selected from a group of means comprising:
a) special screw seal;
b) sealed wire passing through screw head;
c) seal-sticker put on an enclosure lid;
d) mechanical key;
e) electronic contact key;
f) electronic contactless key;
g) combination of mechanical and electronic contact key;
h) combination of mechanical and electronic contactless key;
i) keyboard for entering code sequence;
j) keyboard for entering code sequence using coded duration of particular keys;
k) unintelligent access card, which comprises: card with magnetic stripe, barium ferrite and wiegand-effect, passive and active proximity cards;
l) intelligent access cards, which comprises: contact intelligent cards and RFID intelligent cards;
m) fingerprint recognition device;
n) hand geometry recognition device;
o) face recognition device;
p) iris recognition device;
q) voice recognition device;
r) dynamic signature recognition device;
s) vein scan recognition device;
t) face thermography recognition device;
u) skin pattern recognition device;
v) nail bed recognition device;
w) blood pulse measurement recognition device;
x) biometric sensor;
y) means for the prevention of opening of a enclosure; and
z) means for enabling opening of an enclosure, wherein a way of the activation of access control device (d) to (x) generates authorization type.

11. The turnover controller of claim 1, wherein the turnover controller (2) receives key codes from at least one interface selected from a group of interfaces comprising:
a) the keyboard (20);
b) the communication device (19);
c) the wired port connector (25);
d) the wireless port connector (26); and
e) the self-test software generator inside program in the program memory (11).

12. The turnover controller of claim 1, further connected to a device selected from a group of devices comprising:
a) PC;
b) POS;
c) card reader (POS-EFT);
d) bar code reader;
e) laser scanner;
f) additional monitor;
g) kitchen printer;
h) bar printer;
i) scale;
j) magnetic stripe reader;
k) optical character recognition apparatus (OCRA);
l) machine vision camera;
m) RFID interrogator; and
n) GPS receiver.

13. A method of controlling turnover, comprising the steps of:
a) providing data security of a turnover controller (2);
b) data communicating between the turnover controller (2) and a server (1);
c) registering the turnover controller (2) on the server (1); and
d) turnover registration by the turnover controller (2).

14. The method of claim 13, which further comprises at least one step selected from a group of steps comprising:
a) deregistering the turnover controller (2) on the server (1);
b) self-testing of the turnover controller (2);
c) data exchange between the turnover controller of a seller and the turnover controller of a buyer; and
d) servicing of the turnover controller (2).

15. The method of claim 13, wherein the data of the turnover controller (2) comprise at least one type of record in the log memory (13) selected from a group of types of records comprising:
a) authentication code of the manufacturer of the turnover controller (2);
b) authentication code of a tax payer;
c) production number of the turnover controller (2);
d) production number of the first set of parts (3);
e) production number of parts from the second set of parts (4);
f) identification number of the turnover controller (2);
g) identification number of the tax payer;
h) name and address of the headquarters of the manufacturer of the turnover controller (2), date and time of entering name and address of the headquarters of the manufacturer;
i) name and address of a distribution location of the manufacturer of the turnover controller (2), date and time of entering name and address of the distribution location;
j) name and address of the headquarters of the tax payer, date and time of entering name and address of the headquarters of the tax payer;
k) name and address of a sale location of the tax payer, date and time of entering name and address of the sale location;
l) type of an error, date and time of error detection;
m) type of a service, date and time of beginning and end of the service;
n) type of a reset, date and time of reset activation;
o) type of a self-test, result of the self-test, date and time of the self-test;
p) type of an authorization, date and time of opening and closing of the first enclosure (5);
q) type of an authorization, date and time of opening and closing of at least one of the second enclosure (6);
r) serial number of a record in the log memory (13), date and time of sending a log file and date and time of receiving correct log file on the server (1);
s) serial number of a record in the transaction memory (15), date and time of sending a transaction file and date and time of receiving correct transaction file on the server (1);
t) serial number of a record in the turnover memory (16), date and time of sending a turnover file and date and time of receiving correct turnover file on the server (1);
u) commands, date and time of receiving commands in the turnover controller (2);
v) program signature, date and time of receiving a program in the turnover controller (2); and
w) tax rates, date and time of receiving tax rates in the turnover controller (2).

16. The method of claim 15, wherein the identification number of the turnover controller (2) comprises at least one identification code selected from a group of identification codes comprising:
a) identification code of a particular state in which the turnover controller (2) controls turnover;
b) identification code of the manufacturer of the turnover controller (2);
c) identification code of a type of the turnover controller (2); and
d) identification code of the turnover controller (2) itself.

17. The method of claim 15, wherein the identification number of the tax payer comprises at least one identification code selected from a group of identification codes comprising:
a) identification code of a particular state in which turnover of the tax payer is controlled;
b) unique identification code of the tax payer;
c) registered identification code of the tax payer for value added tax; and
d) registered identification code of the tax payer for sales tax.

18. The method of claim 15, wherein at least one type of error is selected from a group of errors comprising:
a) the turnover controller (2) is not registered on the server (1);
b) the turnover controller (2) is deregistered on the server (1);
c) the program memory (11) is defective;
d) the operating memory (12) is defective;
e) the log memory (13) is defective;
f) the PLU memory (14) is defective;
g) the transaction memory (15) is defective;
h) the turnover memory (16) is defective;
i) the keyboard (20) is defective;
j) the display (21) is defective;
k) the printer (22) is defective;
l) a paper tape is missing in the printer (22);
m) the power supply (23) voltage is higher than predefined overvoltage level;
n) the power supply (23) voltage is lower than predefined undervoltage level;
o) the seller's display (24) is defective;
p) a number of records of particular type in the log memory (13) reached predefined number for that type of records;
q) a number of records of particular type in the log memory (13) reached predefined number for that type of records, and all records of that type have not been sent to the server (1) before writing of new records of that type in the log memory (13);
r) a number of records of particular type in the transaction memory (15) reached predefined number for that type of records;
s) a number of records of particular type in the transaction memory (15) reached predefined number for that type of records, and all records of that type have not been sent to the server (1) before writing of new records of that type in the transaction memory (15);
t) a number of records of particular type in the turnover memory (16) reached predefined number for that type of records; and
u) a number of records of particular type in the turnover memory (16) reached predefined number for that type of records, and all records of that type have not been sent to the server (1) before writing of new records of that type in the turnover memory (16).

19. The method of claim 15, wherein at least one type of service is selected from a group of types of services comprising:
a) unjustified requested service;
b) technical inspection;
c) repair without opening of the first enclosure (5);
d) repair without opening of the second enclosure (6);
e) repair with opening of the first enclosure (5);
f) repair with opening of the second enclosure (6);
g) disassembly of at least one part of the second set of parts (4) after opening of the second enclosure (6);
h) assembly of at least one part of the second set of parts (4) after removal of at least part of the second set of parts (4);
i) disassembly of existing first set of parts (3) after opening of the first enclosure (5); and
j) assembly of new first set of parts (3) after removal of existing first set of parts (3).

20. The method of claim 15, wherein at least one type of reset is selected from a group of types of resets comprising:
a) program deblocking without clear of data relevant to turnover registration in the operating memory (12) based on received key code;
b) activation of predefined commands instead of last received commands from the server (1), after opening of the second enclosure (6) and entering request for the activation; and
c) complete clearing of the operating memory (12) after opening the first enclosure (5) and entering request for clearing.

21. The method of claim 15, wherein at least one type of self-test is selected from a group of types of self-tests comprising:
a) self-test of the microprocessor (10);
b) self-test of the program memory (11);
c) self-test of the operating memory (12);
d) self-test of the log memory (13);
e) self-test of the PLU memory (14);
f) self-test of the transaction memory (15);
g) self-test of the turnover memory (16);
h) self-test of the communication device (19);
i) self-test of the keyboard (20);
j) self-test of the display (21);
k) self-test of the printer (22);
l) self-test of the power supply (23);
m) self-test of the seller's display (24); and
n) self-test of data exchange between the turnover controller (2) and the server (1).

22. The method of claim 15, wherein at least one type of authorization is selected from a group of types of authorizations comprising:
a) authorization for opening of the first enclosure (5);
b) non-authorization for opening of the first enclosure (5);
c) authorization for opening of the second enclosure (6); and
d) non-authorization for opening of the second enclosure (6).

23. The method of claim 15, wherein at least one command is selected from a group of commands comprising:
a) assignment of an identification number of the turnover controller (2);
b) assignment of an identification number of tax payer;
c) assignment of tax rates, date and time of beginning of validity of tax rates;
d) receiving a command file from the server (1);
e) receiving a program file from the server (1);
f) date and time for sending data to the server (1);
g) period and time for sending data to the server (1);
h) sending all data to the server (1);
i) sending data within requested time interval to the server (1);
j) sending unseat data to the server (1);
k) synchronization of date and time of the turnover controller (2) with the server (1);
l) self-test type;
m) status type;
n) sending a log file to the server (1);
o) sending a transaction file to the server (1);
p) sending a transaction file of selected PLUs to the server (1);
q) sending a turnover file to the server (1);
r) assignment of an encryption key for the first set of parts (3); and
s) assignment of an encryption key for parts of the second set of parts (4).

24. The method of claim 23, wherein status type is selected from a group of status types comprising:
a) an approval of the registration of the turnover controller (2) on the server (1), in case of valid authentication code of the manufacturer of the turnover controller (2);
b) a disapproval of the registration of the turnover controller (2) on the server (1), in case of invalid authentication code of the manufacturer of the turnover controller (2);
c) an approval of the registration of the turnover controller (2) on the server (1), in case that an electronic address of the turnover controller (2) is within the range of electronic addresses assigned to the manufacturer of the turnover controller (2);
d) a disapproval of the registration of the turnover controller (2) on the server (1), in case that an electronic address of the turnover controller (2) is outside the range of electronic addresses assigned to the manufacturer of the turnover controller (2);
e) an approval of the registration of the turnover controller (2) on the server (1), in case that a position of the turnover controller (2) is different from a position of a distribution location for less than a predefined number;
f) a disapproval of the registration of the turnover controller (2) on the server (1), in case that the position of the turnover controller (2) is different from the position of the distribution location for more than a predefined number;
g) an approval of the registration of the turnover controller (2) on the server (1), in case of valid authentication code of a tax payer;
h) a disapproval of the registration of the turnover controller (2) on the server (1), in case of invalid authentication code of the tax payer;
i) an approval of the registration of the turnover controller (2) on the server (1), in case that an electronic address of the turnover controller (2) is within the range of electronic addresses assigned to the tax payer;
j) a disapproval of the registration of the turnover controller (2) on the server (1), in case that an electronic address of the turnover controller (2) is outside the range of electronic addresses assigned to the tax payer;
k) an approval of the registration of the turnover controller (2) on the server (1), in case that a position of the turnover controller (2) is different from a position of a sale location for less than a predefined number; and
l) a disapproval of the registration of the turnover controller (2) on the server (1), in case that the position of the turnover controller (2) is different from the position of the sale location for more than a predefined number.

25. The method of claim 13, wherein the data of the turnover controller (2) comprise at least one type of record in the PLU memory (14) selected from a group of types of records comprising:
a) PLU code;
b) PLU name;
c) tax rate assigned to PLU;
d) name of PLU metric unit; and
e) price of PLU metric unit.

26. The method of claim 13, wherein the data of the turnover controller (2) comprise at least one type of record in the transaction memory (15) selected from a group of types of records comprising:
a) serial number of a fiscal receipt, date and time of forming that fiscal receipt;
b) individual recorded transactions;
c) individual cancelled recorded transactions;
d) serial number of a refunded receipt, date and time of forming that refunded receipt;
e) individual refunded transactions;
f) individual cancelled refunded transactions;
g) payment amounts per each payment means;
h) identification number of the turnover controller of a buyer; and
i) identification number of a buyer.

27. The method of claim 26, wherein a transaction comprises at least one type of records selected from a group of types of records comprising:
a) PLU code;
b) PLU name;
c) tax rate assigned to PLU;
d) name of PLU metric unit;
e) price of PLU metric unit;
f) PLU quantity;
g) purchased PLU as transaction type;
h) sold PLU as transaction type;
i) returned PLU as transaction type;
j) stored PLU as transaction type;
k) eliminated PLU as transaction type; and
l) stolen PLU as transaction type.

28. The method of claim 13, wherein the data of the turnover controller (2) comprise at least one type of records in the turnover memory (16) selected from a group of types of records comprising:
a) serial number of last fiscal receipt before forming daily report;
b) summary recorded turnover per each tax rate;
c) total summary recorded turnover for all tax rates;
d) summary canceled recorded turnover per each tax rate;
e) total summary canceled recorded turnover for all tax rates;
f) difference between summary recorded turnover and summary canceled recorded turnover per each tax rate;
g) difference between summary recorded turnover and summary canceled recorded turnover for all tax rates;
h) serial number of last refunded receipt before forming daily report;
i) summary refunded turnover per each tax rate;
j) total summary refunded turnover for all tax rates;
k) summary canceled refunded turnover per each tax rate;
l) total summary canceled refunded turnover for all tax rates;
m) difference between summary refunded turnover and summary canceled refunded turnover per each tax rate;
n) difference between summary refunded turnover and summary canceled refunded turnover for all tax rates;
o) serial number of daily report, date and time of forming daily report; and
p) payment amounts per each payment means, selected from a group comprising: cash, payment cards, checks and money transfer between bank accounts.

29. The method of claim 13, wherein the step for providing data security comprises at least one step selected from a group of steps comprising:
a) management of the first opening controller (7);
b) management of the second opening controller (8);
c) management of the program memory (11);
d) management of the operating memory (12);
e) management of the log memory (13);
f) management of the PLU memory (14);
g) management of the transaction memory (15);
h) management of the turnover memory (16);
i) prevention of turnover registration;
j) protection of serial number counters;
k) management of the display (21); and
l) management of the printer (22).

30. The method of claim 29, wherein the step of the management of the first opening controller (7) comprises at least one step selected from a group of steps comprising:
a) storing of a type of the authorization for opening of the first enclosure (5) in the log memory (13);
b) storing date and time of the opening of the first enclosure (5) in the log memory (13);
c) storing date and time of the closing of the first enclosure (5) in the log memory (13);
d) disabling further turnover registration using the turnover controller (2) in case of unauthorized opening of the first enclosure (5);
e) disabling opening of the first enclosure (5); and
f) free opening of the first enclosure (5).

31. The method of claim 29, wherein the step of the management of the second opening controller (8) comprises at least one step selected from a group of steps comprising:
a) storing of a type of the authorization for opening of the second enclosure (6) in the log memory (13);
b) storing date and time of the opening of the second enclosure (6) in the log memory (13);
c) storing date and time of the closing of the second enclosure (6) in the log memory (13);
d) disabling further turnover registration using the turnover controller (2) in case of unauthorized opening of the second enclosure (6);
e) disabling opening of the second enclosure (6); and
f) free opening of the second enclosure (6).

32. The method of claim 29, wherein the step of the management of the program memory (11) comprises at least one step selected from a group of steps comprising:
a) retention in the program memory (11) a program independently from the power supply;
b) storing in the program memory (11) a complete program with update capability;
c) storing in a first part of the program memory (11) basic program without update capability, which serves for registering the turnover controller (2) on the server (1) and update of additional programs;
d) storing in a second part of the program memory (11) additional programs with update capability;
e) protection of the program memory (11) from change or clear;
f) protection of the program memory (11) from change or clear, unless it is requested by a command for receiving a program file from the server (1);
g) protection of the first part of the program memory (11) from change or clear; and
h) protection of the second part of the program memory (11) from change or clear, unless it is requested by the command for receiving the program file from the server (1).

33. The method of claim 29, wherein the step of the management of the operating memory (12) comprises at least one step selected from a group of steps comprising:
a) retention in the operating memory (12) data independently from the power supply;
b) storing in the operating memory (12) program variables;
c) protection of the operating memory (12) from clear; and
d) protection of the operating memory (12) from clear, unless it is requested after reset.

34. The method of claim 29, wherein the step of the management of the log memory (13) comprises at least one step selected from a group of steps comprising:
a) retention in the log memory (13) data independently from the power supply;
b) protection of the log memory (13) from change of data;
c) protection of the log memory (13) from clear of data; and
d) protection of the log memory (13) from clear of data that are not sent to the server (1).

35. The method of claim 29, wherein the step of the management of the PLU memory (14) comprises at least one step selected from a group of steps comprising:
a) retention in the PLU memory (14) data independently from the power supply;
b) protection of the PLU memory (14) from clear of data; and
c) protection of the PLU memory (14) from clear of data, unless it is requested by commands for PLU base handling from the other server.

36. The method of claim 29, wherein the step of the management of the transaction memory (15) comprises at least one step selected from a group of steps comprising:
a) retention in the transaction memory (15) data independently from the power supply;
b) protection of the transaction memory (15) from change of data;
c) protection of the transaction memory (15) from clear of data; and
d) protection of the transaction memory (15) from clear of data that are not sent to the server (1).

37. The method of claim 29, wherein the step of the management of the turnover memory (16) comprises at least one step selected from a group of steps comprising:
a) retention in the turnover memory (16) data independently from the power supply;
b) protection of the turnover memory (16) from change of data;
c) protection of the turnover memory (16) from clear of data; and
d) protection of the turnover memory (16) from clear of data that are not sent to the server (1).

38. The method of claim 29, wherein the step of the prevention of turnover registration comprises prevention of turnover registration because of at least one error selected from a group of errors listed in claim 18.

39. The method of claim 29, wherein at least one serial number counter is selected from a group of counters comprising:
a) serial number counter of data records in the log memory (13);
b) serial number counter of data records in the transaction memory (15); and
c) serial number counter of data records in the turnover memory (16).

40. The method of claim 29, wherein the step of the management of the display (21) comprises prevention of direct displaying of messages from at least one interface listed in claim 11.

41. The method of claim 29, wherein the step of the management of the printer (22) comprises at least one step selected from a group of steps comprising:
a) continuation of printing until the end of line during power down;
b) continuation of temporarily stopped printing after power up;
c) continuation of temporarily stopped printing after printer malfunction and servicing;
d) prevention of printing of documents before the registration of the turnover controller (2) on the server (1);
e) prevention of printing of documents after the deregistration of the turnover controller (2) on the server (1);
f) prevention of printing of non-fiscal documents with names and prices of goods and services and turnovers from fiscal documents;
g) printing of a fiscal logo only on fiscal documents;
h) prevention of printing of non-fiscal documents with symbols similar to the fiscal logo; and
i) prevention of direct printing of messages from at least one interface listed in claim 11.

42. The method of claim 13, wherein the step of data exchange between the turnover controller (2) and the server (1) comprises at least one step selected from a group of steps comprising:
a) utilization of a communication protocol;
b) data authentication;
c) data encryption;
d) data decryption;
e) definition of access rights;
f) generation of a request for calling the server (1);
g) selection of data for sending to the server (1);
h) selection of data for receiving from the server (1);
i) creation of a filename of a file for sending to the server (1);
j) creation of a filename of a file for receiving from the server (1);
k) sending data to the server (1);
l) receiving data from the server (1);
m) synchronizing date and time of the turnover controller (2) with date and time of the server (1); and
n) data exchange between the turnover controller (2) and other servers.

43. The method of claim 42, wherein the step of the utilization of communication protocol comprises at least one method selected from a group of methods comprising:
a) Pretty Good Privacy (PGP);
b) Secure Shell (SSH);
c) Security Socket Layer (SSL);
d) Transport Layer Security (TSL);
e) IP Security (IPsec);
f) HyperText Transmission Protocol (HTTP);
g) File Transfer Protocol (FTP);
h) Secure HyperText Transmission Protocol (SHTTP);
i) Secure File Transfer Protocol (SFTP); and
j) Secure Electronic Transaction (SET).

44. The method of claim 42, wherein the step of data authentication comprises at least one method selected from a group of methods comprising:
a) Message Digest (MD5);
b) Secure Hash Algorithm (SHA);
c) Keyed Hash Message Authentication Code (HMAC);
d) Direct Digital Signature;
e) Arbitrary Digital Signature;
f) Digital Signature Standard (DSS);
g) Mutual Authentication;
h) Authentication with Public Key;
i) Kerberos;
j) X.509; and
k) Zero Knowledge Proof.

45. The method of claim 42, wherein at least one step of data encryption and data decryption steps comprises at least one method selected from a group of methods comprising:
a) Rivest Shamir Adelman (RSA);
b) Data Encryption Standard (DES);
c) Triple-Pass DES (EDE);
d) Triple DES (3DES);
e) RC2;
f) RC4;
g) RC6;
h) Rijndmael alias Advanced Encryption Standard (AES);
i) International Data Encryption Algorithm (IDEA);
j) Diffie-Hellman;
k) El Gamal;
l) Blowfish;
m) One-time-pad;
n) Substitution;
o) Permutation; and
p) Garbage-in-between.

46. The method of claim 42, wherein the step of definition of access rights comprises at least one step selected from a group of steps comprising:
a) definition of access rights to a network with the server (1);
b) definition of an address of the server (1) in said network;
c) definition of access rights to the server (1);
d) definition of folder name in the server (1) for receiving log files;
e) definition of folder name in the server (1) for receiving transaction files;
f) definition of folder name in the server (1) for receiving turnover files;
g) definition of folder name in the server (1) for storing command files; and
h) definition of folder name in the server (1) for storing program files.

47. The method of claim 42, wherein the step of generation of a request for calling the server (1) comprises at least one step selected from a group of steps comprising:
a) automatic generation of the request for calling the server (1) on the basis of commands;
b) generation of the request for calling the server (1) by polling the turnover controller (2);
c) generation of the request for calling the server (1) on the basis of received call;
d) generation of the request for calling the server (1) on the basis of received SMS message; and
e) generation of the request for calling the server (1) on the basis of received e-mail.

48. The method of claim 42, wherein the selected data for sending to the server (1) comprise at least one record selected from a group of records comprising:
a) records from the log memory (13) for a log file;
b) records from the transaction memory (15) for transaction file; and
c) records from the turnover memory (16) for a turnover file.

49. The method of claim 42, wherein the selected data for receiving from the server (1) comprise at least one record selected from a group of records comprising:
a) commands for a command file; and
b) program for a program file.

50. The method of claim 42, wherein a filename of a file for sending to the server (1) comprises an identification number of the turnover controller (2) and a partial filename selected from a group of partial filenames comprising:
a) partial log filename for a log file;
b) partial transaction filename for a transaction file; and
c) partial turnover filename for a turnover file.

51. The method of claim 42, wherein a filename of a file for receiving from the server (1) comprises an identification number of the turnover controller (2) and a partial filename selected from a group of partial filenames comprising:
a) partial command filename for a command file; and
b) partial program filename for a program file.

52. The method of claim 42, wherein the step of sending data to the server (1) comprises steps of:
a) sending to the server (1) a file selected from a group of files comprising: a log file, a transaction file and a turnover file;
b) receiving an acknowledge from the server (1);
c) checking correctness of the file received by the server (1) using the received acknowledge; and
d) performing steps a) through d) at most predefined number of tries per day in predefined time intervals, in case of receiving incorrect file by the server (1).

53. The method of claim 42, wherein the step of sending data to the server (1) further comprises at least one of the steps selected from a group of steps comprising:
a) activating first visual indication within the predefined time interval before sending a file;
b) deactivating first visual indication and activating second visual indication during creating of the file;
c) deactivating second visual indication and activating third visual indication after the file was created; and
d) deactivating third visual indication after receiving correct file by the server (1).

54. The method of claim 42, wherein the step of receiving file comprises steps of:
a) receiving from the server (1) a file selected from a group of files comprising: a command file and a program file;
b) checking correctness of received file and correctness of a filename of received file;
c) performing steps a) through c) at most predefined number of tries per day in predefined time intervals, in case of receiving incorrect file or incorrect filename;
d) rejecting incorrect received file and continuing use of current file; and
e) starting use of correct received file instead of current file.

55. The method of claim 42, wherein the step of receiving file comprises steps of:
a) receiving file signature from the server (1);
b) comparing received file signature with current file signature;
c) skipping all steps d) through i), in case that current file signature is identical to received file signature;
d) performing steps e) through i) in case that current file signature is different from received file signature;
e) receiving a file from the server (1) selected from a group of files comprising: a command file and a program file;
f) checking correctness of received file and correctness of a filename of received file;
g) performing steps e) through g) at most predefined number of tries per day in predefined time intervals, in case of receiving incorrect file or incorrect filename;
h) rejecting incorrect received file and continuing use of current file instead; and
i) starting use of correct received file instead of current file.

56. The method of claim 42, wherein the step of synchronizing date and time of the turnover controller (2) with date and time of the server (1) comprises at least one step selected from a group of steps comprising:
a) synchronization of a real-time clock (17) of the turnover controller (2) with a real-time clock of the server (1) using NTP (Network Time Protocol), based on time synchronization command; and
b) automatic switch between summer and winter time, according to the appropriate legislation.

57. The method of claim 42, wherein the step of data exchange between the turnover controller (2) and other servers comprises at least one step selected from a group of steps comprising:
a) receiving from a second server PLU base, which for each PLU comprises: PLU code, PLU name, tax rate assigned to PLU, name of PLU metric unit and price of PLU metric unit;
b) receiving from the second server a file for adding selected PLU in PLU base;
c) receiving from the second server a file for clearing selected PLU in PLU base;
d) receiving from the second server a file for updating selected PLU in PLU base;
e) receiving from the second server a file for updating prices of PLU metric unit of selected PLU in PLU base;
f) sending to the second server a complete PLU base;
g) sending to the second server a list of sold PLU;
h) sending to the second server a list of unsold PLU;
i) sending to the second server a list of refunded PLU;
j) sending to a third server a request for recharging prepaid SIM card;
k) receiving from the third server a pin code for recharging prepaid SIM card and printing of received pin code on the printer (22);
l) receiving from the third server a pin code for recharging prepaid SIM card and printing of received pin code on an additional printer;
m) sending to a fourth server lottery digits;
n) receiving from the fourth server a lottery confirmation code and its printing on the printer (22);
o) receiving from the fourth server a lottery confirmation code and its printing on the additional printer;
p) receiving from a fifth server advertising messages for showing on the display (21);
q) receiving from the fifth server time schedule for showing messages on the display (21);
r) receiving from a sixth server advertising messages for showing on the seller's display (24);
s) receiving from the sixth server time schedule for showing messages on the seller's display (24);
t) receiving from a seventh server advertising messages for showing on an additional monitor;
u) receiving from the seventh server time schedule for showing messages on the additional monitor;
v) sending to an eight server data from payment card readers;
w) receiving from the eight server data for payment card readers;
x) sending to a ninth server data from an intruder alarm detector;
y) sending to the ninth server video data from a surveillance camera;
z) sending to the ninth server audio data from a microphone; and
aa) sending to a tenth server data from fire alarm detector.

58. The method of claim 13, wherein the step of registering the turnover controller (2) on the server (1) comprises steps of:
a) entering an authentication code of the manufacturer of the turnover controller (2) into the turnover controller (2);
b) sending to the server (1) of the authentication code of the manufacturer of the turnover controller (2);
c) receiving a disapproval of the registration of the turnover controller (2) on the server (1), in case of invalid authentication code of the manufacturer of the turnover controller (2); and
d) receiving an identification number of the turnover controller (2) from the server (1) and its writing into the turnover controller (2), in case of valid authentication code of the manufacturer of the turnover controller (2).

59. The method of claim 13, wherein the step of registering the turnover controller (2) on the server (1) comprises steps of:
a) sending a range of electronic addresses assigned to the manufacturer of the turnover controller (2) to the server (1) from the telecommunication operator;
b) receiving a disapproval of the registration of the turnover controller (2) on the server (1), in case that an electronic address of the turnover controller (2) is outside the range of electronic addresses assigned to the manufacturer of the turnover controller (2); and
c) receiving an approval of the registration of the turnover controller (2) on the server (1), in case that the electronic address of the turnover controller (2) is within the range of electronic addresses assigned to the manufacturer of the turnover controller (2).

60. The method of claim 13, wherein the step of registering the turnover controller (2) on the server (1) comprises steps of:
a) sending a position of a distribution location to the server (1) from the telecommunication operator;
b) writing the distribution location into the turnover controller (2);
c) sending a log file to the server (1);
d) sending a position of the turnover controller (2) to the server (1) from the telecommunication operator;
e) receiving a disapproval of the registration of the turnover controller (2) on the server (1), in case that the position of the turnover controller (2) is different from the position of the distribution location for more than a predefined number; and
f) receiving an approval of the registration of the turnover controller (2) on the server (1), in case that the position of the turnover controller (2) is different from the position of the distribution location for less than a predefined number.

61. The method of claim 13, wherein the step of registering the turnover controller (2) on the server (1) comprises steps of:
a) sending to the server (1) a list of parts assembled into the turnover controller (2), comprising: a production number of a part, a secret key for that part in case of a symmetric encryption, or a public key for that part in case of an asymmetric encryption;
b) sending a log file to the server (1);
c) receiving a disapproval of the registration of the turnover controller (2) on the server (1), in case that the production number of at least one part of the turnover controller (2) is not on the list of parts assembled in the turnover controller (2); and
d) receiving an approval of the registration of the turnover controller (2) on the server (1), in case that the production numbers of all parts of the turnover controller (2) are on the list of parts assembled in the turnover controller (2).

62. The method of claim 13, wherein the step of registering the turnover controller (2) on the server (1) comprises steps of:
a) sending to the server (1) a list of parts assembled into the turnover controller (2), comprising: a production number of a part, a secret key for that part in case of a symmetric encryption, or a public key for that part in case of an asymmetric encryption;
b) sending a log file to the server (1);
c) receiving a disapproval of the registration of the turnover controller (2) on the server (1), in case that a communication with at least one part of the turnover controller (2) cannot be performed with the key for that part from the list of parts assembled in the turnover controller (2); and
d) receiving an approval of the registration of the turnover controller (2) on the server (1), in case that a communication with each part of the turnover controller (2) can be performed with the key for that part from the list of parts assembled in the turnover controller (2).

63. The method of claim 13, wherein the step of registering the turnover controller (2) on the server (1) comprises steps of:
a) entering an authentication code of the manufacturer of the turnover controller (2) into the turnover controller (2) and its storing in the log memory (13);
b) sending a log file to the server (1);
c) receiving an acknowledge from the server (1);
d) checking correctness of the log file received by the server (1) using the received acknowledge from the server (1);
e) performing steps b) through e) at most predefined number of tries per day in predefined time intervals, in case of receiving incorrect log file by the server (1);
f) receiving a command file from the server (1) in case of receiving correct log file by the server (1);
g) checking correctness of received command file and correctness of a filename of received command file;
h) performing steps f) through h) at most predefined number of tries per day in predefined time intervals, in case of receiving incorrect command file or incorrect command filename;
i) rejecting received incorrect command file and continuing use of current command file;
j) starting use of received correct command file instead of current command file;
k) extracting a disapproval of the registration of the turnover controller (2) on the server (1), in case of invalid authentication code of the manufacturer of the turnover controller (2); and
l) extracting an approval of the registration of the turnover controller (2) on the server (1) and the identification number of the turnover controller (2) from received correct command file and its storing in the log memory (13), in case of valid authentication code of the manufacturer of the turnover controller (2).

64. The method of claim 13, wherein the step of registering the turnover controller (2) on the server (1) comprises steps of:
a) entering an authentication code of a tax payer into the turnover controller (2);
b) sending to the server (1) of the authentication code of the tax payer;
c) receiving a disapproval of the registration of the turnover controller (2) on the server (1), in case of invalid authentication code of the tax payer; and
d) receiving an identification number of the turnover controller (2) from the server (1) and its writing into the turnover controller (2), in case of valid authentication code of the tax payer.

65. The method of claim 13, wherein the step of registering the turnover controller (2) on the server (1) comprises steps of:
a) sending a range of electronic addresses assigned to a tax payer to the server (1) from the telecommunication operator;
b) receiving a disapproval of the registration of the turnover controller (2) on the server (1), in case that an electronic address of the turnover controller (2) is outside the range of electronic addresses assigned to the tax payer; and
c) receiving an approval of the registration of the turnover controller (2) on the server (1), in case that the electronic address of the turnover controller (2) is within the range of electronic addresses assigned to the tax payer.

66. The method of claim 13, wherein the step of registering the turnover controller (2) on the server (1) comprises steps of:
a) sending a position of a sale location to the server (1) from the telecommunication operator;
b) writing the sale location into the turnover controller (2);
c) sending a log file to the server (1);
d) sending a position of the turnover controller (2) to the server (1) from the telecommunication operator;
e) receiving a disapproval of the registration of the turnover controller (2) on the server (1), in case that the position of the turnover controller (2) is different from the position of the sale location for more than a predefined number; and
f) receiving an approval of the registration of the turnover controller (2) on the server (1), in case that the position of the turnover controller (2) is different from the position of the sale location for less than a predefined number.

67. The method of claim 13, wherein the step of registering the turnover controller (2) on the server (1) comprises steps of:
a) entering an authentication code of a tax payer into the turnover controller (2) and its storing in the log memory (13);
b) sending a log file to the server (1);
c) receiving an acknowledge from the server (1);
d) checking correctness of the log file received by the server (1) using the received acknowledge from the server (1);
e) performing steps b) through e) at most predefined number of tries per day in predefined time intervals, in case of receiving incorrect log file by the server (1);
f) receiving a command file from the server (1) in case of receiving correct log file by the server (1);
g) checking correctness of received command file and correctness of a filename of received command file;
h) performing steps f) through h) at most predefined number of tries per day in predefined time intervals, in case of receiving incorrect command file or incorrect command filename;
i) rejecting received incorrect command file and continuing use of current command file;
j) starting use of received correct command file instead of current command file;
k) extracting a disapproval of the registration of the turnover controller (2) on the server (1), in case of invalid authentication code of tax payer; and
l) extracting an approval of the registration of the turnover controller (2) on the server (1) and an identification number of the tax payer from received correct command file and its storing in the log memory (13), in case of valid authentication code of the tax payer.

68. The method of claim 13, wherein the step of turnover registration comprises steps of:
a) receiving key codes;
b) parsing received key codes;
c) rejecting incorrect key code sequences;
d) executing correct key code sequences; and
e) repeating steps a) through e) until receiving stop key code.

69. The method of claim 68, wherein the step of executing correct key code sequences comprises at least one step selected from a group of steps comprising:
a) entering individual recorded transactions;
b) entering individual canceled recorded transactions;
c) entering individual refunded transactions;
d) entering individual canceled refunded transactions;
e) summing turnovers from individual recorded transactions per each tax rate;
f) summing turnovers from individual recorded transactions for all tax rates;
g) summing turnovers from individual canceled recorded transactions per each tax rate;
h) summing turnovers from individual canceled recorded transactions for all tax rates;
i) summing turnovers from individual recorded transactions per each tax rate and subtracting turnovers from individual canceled recorded transactions per each tax rate;
i) summing turnovers from individual recorded transactions for all tax rates and subtracting turnovers from individual canceled recorded transactions for all tax rates;
k) summing turnovers from individual refunded transactions per each tax rate;
l) summing turnovers from individual refunded transactions for all tax rates;
m) summing turnovers from individual canceled refunded transactions per each tax rate;
n) summing turnovers from individual canceled refunded transactions for all tax rates;
o) summing turnovers from individual refunded transactions per each tax rate and subtracting turnovers from individual canceled refunded transactions per each tax rate;
p) summing turnovers from individual refunded transactions for all tax rates and subtracting turnovers from individual canceled refunded transaction for all tax rates;
q) presenting records from a memory selected from a group of memories, comprising: the program memory (11), the operating memory (12), the log memory (13), the PLU memory (14), the transaction memory (15) and the turnover memory (16);
r) entering into the transaction memory (15) the amount of cash in deposited by a cashier;
s) entering into the transaction memory (15) the amount of cash out withdrawn by a cashier;
t) entering into the transaction memory (15) payment means per each type of payment means; and
u) presenting records from a memory.

70. The method of claim 69, wherein the step of presenting records from a memory comprises at least one step selected from a group of steps comprising:
a) displaying records on the display (21);
b) displaying records on the seller's display (24);
c) printing records on the printer (22); and
d) playing audio records.

71. The method of claim 68, wherein the step of executing correct key code sequence comprises at least one step selected from a group of steps comprising:
a) writing of a complete PLU base in the PLU memory (14);
b) adding selected PLU in the PLU base in the PLU memory (14);
c) clearing selected PLU in PLU base in the PLU memory (14);
d) updating selected PLU in PLU base in the PLU memory (14);
e) updating price of a metric unit of selected PLU in PLU base in the PLU memory (14);
f) reading the complete PLU base from the PLU memory (14);
g) reading a list of sold PLU from the PLU memory (14);
h) reading a list of unsold PLU from the PLU memory (14); and
i) reading a list of refunded PLU from the PLU memory (14).

72. The method of claim 14, wherein the step of deregistering the turnover controller (2) on the server (1) comprises steps of:
a) entering an authentication code of a tax payer into the turnover controller (2);
b) sending to the server (1) of the authentication code of the tax payer;
c) receiving a disapproval of the deregistration of the turnover controller (2) on the server (1), in case of invalid authentication code of the tax payer; and
d) receiving predefined identification number of the turnover controller (2) on the server (1) and its writing into the turnover controller (2), in case of valid authentication code of the tax payer.

73. The method of claim 14, wherein the step of deregistering the turnover controller (2) on the server (1) comprises steps of:
a) sending a range of electronic addresses assigned to a tax payer to the server (1) from the telecommunication operator;
b) receiving a disapproval of the deregistration of the turnover controller (2) on the server (1), in case that an electronic address of the turnover controller (2) is outside the range of electronic addresses assigned to a tax payer; and
c) receiving an approval of the deregistration of the turnover controller (2) on the server (1), in case that the electronic address of the turnover controller (2) is within the range of electronic addresses assigned to the tax payer.

74. The method of claim 14, wherein the step of deregistering the turnover controller (2) on the server (1) comprises steps of:
a) sending a position of a sale location to the server (1) from the telecommunication operator;
b) writing the sale location into the turnover controller (2);
c) sending a log file to the server (1);
d) sending a position of the turnover controller (2) to the server (1) from the telecommunication operator;
e) receiving a disapproval of the deregistration of the turnover controller (2) on the server (1), in case that the position of the turnover controller (2) is different from the position of the sale location for more than a predefined number; and
f) receiving an approval of the deregistration of the turnover controller (2) on the server (1), in case that the position of the turnover controller (2) is different from the position of the sale location for less than a predefined number.

75. The method of claim 14, wherein the step of deregistering the turnover controller (2) on the server (1) comprises steps of:
a) entering an authentication code of a tax payer into the turnover controller (2) and its storing in the log memory (13);
b) sending a log file to the server (1);
c) receiving an acknowledge from the server (1);
d) checking correctness of the log file received by the server (1) using the received acknowledge from the server (1);
e) performing steps b) through e) at most predefined number of tries per day in predefined time intervals, in case of receiving incorrect log file by the server (1);
f) receiving a command file from the server (1) in case of receiving correct log file by the server (1);
g) checking correctness of received command file and correctness of a filename of received command file;
h) performing steps f) through h) at most predefined number of tries per day in predefined time intervals, in case of receiving incorrect command file or incorrect command filename;
i) rejecting received incorrect command file and continuing use of current command file;
j) starting use of received correct command file instead of current command file;
k) extracting a disapproval of the deregistration of the turnover controller (2) on the server (1), in case of invalid authentication code of tax payer; and
l) extracting an approval of the deregistration of the turnover controller (2) on the server (1) and predefined identification number of tax payer from received correct command file and its storing in the log memory (13), in case of valid authentication code of tax payer.

76. The method of claim 14, wherein the step of deregistering the turnover controller (2) on the server (1) comprises steps of:
a) entering an authentication code of the manufacturer of the turnover controller (2) into the turnover controller (2);
b) sending to the server (1) of the authentication code of the manufacturer of the turnover controller (2);
c) receiving a disapproval of the deregistration of the turnover controller (2) on the server (1), in case of invalid authentication code of the manufacturer of the turnover controller (2); and
d) receiving predefined identification number of the turnover controller (2) on the server (1) and its writing into the turnover controller (2), in case of valid authentication code of the manufacturer of the turnover controller (2).

77. The method of claim 14, wherein the step of deregistering the turnover controller (2) on the server (1) comprises steps of:
a) sending a range of electronic addresses assigned to the manufacturer of the turnover controller (2) to the server (1) from the telecommunication operator;
b) receiving a disapproval of the deregistration of the turnover controller (2) on the server (1), in case that an electronic address of the turnover controller (2) is outside the range of electronic addresses assigned to the manufacturer of the turnover controller (2); and
c) receiving an approval of the deregistration of the turnover controller (2) on the server (1), in case that the electronic address of the turnover controller (2) is within the range of electronic addresses assigned to the manufacturer of the turnover controller (2).

78. The method of claim 14, wherein the step of deregistering the turnover controller (2) on the server (1) comprises steps of:
a) sending a position of a distribution location to the server (1) from the telecommunication operator;
b) writing the distribution location into the turnover controller (2);
c) sending a log file to the server (1);
d) sending a position of the turnover controller (2) to the server (1) from the telecommunication operator;
e) receiving a disapproval of the deregistration of the turnover controller (2) on the server (1), in case that the position of the turnover controller (2) is different from the position of the distribution location for more than a predefined number; and
f) receiving an approval of the deregistration of the turnover controller (2) on the server (1), in case that the position of the turnover controller (2) is different from the position of the distribution location for less than a predefined number.

79. The method of claim 14, wherein the step of deregistering the turnover controller (2) on the server (1) comprises steps of:
a) sending a log file to the server (1);
b) receiving a disapproval of the deregistration of the turnover controller (2) on the server (1), in case that a production number of at least one part of the turnover controller (2) is not on a list of parts assembled in the turnover controller (2); and
c) receiving an approval of the deregistration of the turnover controller (2) on the server (1), in case that the production number of each part of the turnover controller (2) is on the list of parts assembled in the turnover controller (2).

80. The method of claim 14, wherein the step of deregistering the turnover controller (2) on the server (1) comprises steps of:
a) sending a log file to the server (1);
b) receiving a disapproval of the deregistration of the turnover controller (2) on the server (1), in case that a communication with at least one part of the turnover controller (2) cannot be performed with the key for that part from a list of parts assembled in the turnover controller (2); and
c) receiving an approval of the deregistration of the turnover controller (2) on the server (1), in case that a communication with each part of the turnover controller (2) can be performed with the key for that part from the list of parts assembled in the turnover controller (2).

81. The method of claim 14, wherein the step of deregistering the turnover controller (2) on the server (1) comprises steps of:
a) entering an authentication code of the manufacturer of the turnover controller (2) into the turnover controller (2) and its storing in the log memory (13);
b) sending a log file to the server (1);
c) receiving an acknowledge from the server (1);
d) checking correctness of the log file received by the server (1) using the received acknowledge from the server (1);
e) performing steps b) through e) at most predefined number of tries per day in predefined time intervals, in case of receiving incorrect log file by the server (1);
f) receiving a command file from the server (1) in case of receiving correct log file by the server (1);
g) checking correctness of received command file and correctness of a filename of received command file;
h) performing steps f) through h) at most predefined number of tries per day in predefined time intervals, in case of receiving incorrect command file or incorrect command filename;
i) rejecting received incorrect command file and continuing use of current command file;
j) starting use of received correct command file instead of current command file;
k) extracting a disapproval of the deregistration of the turnover controller (2) on the server (1), in case of invalid authentication code of the manufacturer of the turnover controller (2); and
l) extracting an approval of the deregistration of the turnover controller (2) on the server (1) and the predefined identification number of the turnover controller (2) from received correct command file and its storing in the log memory (13), in case of valid authentication code of the manufacturer of the turnover controller (2).

82. The method of claim 14, wherein the step of self-testing comprises at least one step selected from a group of steps comprising:
a) checking data exchange between parts from the first set of parts (3) and parts from the second set of parts (4) of the turnover controller (2);
b) checking the communication between the turnover controller (2) and the server (1);
c) entering key codes for requesting a type of self-test using at least one interface listed in claim 11;
d) comparing obtained self-test results with expected self-test results stored within program in the program memory (11);
e) sending obtained self-test results to the server (1);
f) comparing received self-test results on the server (1) with expected self-test results store on the server (1); and
g) presenting self-test results.

83. The method of claim 14, wherein the step of data exchange between a turnover controller of a seller and a turnover controller of a buyer exchanges at least one data selected from a group of data comprising:
a) identification number of the turnover controller of a seller;
b) identification number of a seller;
c) identification number of the turnover controller of a buyer;
d) identification number of a buyer;
e) name and address of seller's headquarters, date and time of entering name and address of seller's headquarters;
f) name and address of sale location, date and time of entering name and address of sale location;
g) serial number of fiscal receipt, date and time of forming fiscal receipt;
h) individual recorded transactions;
i) individual cancelled recorded transactions;
j) serial number of refunded receipt, date and time of forming refunded receipt;
k) individual refunded transactions;
l) individual canceled refunded transactions; and
m) payment amounts per each payment means.

84. The method of claim 14, wherein the step of data exchange between a turnover controller of a seller and a turnover controller of a buyer comprises at least one step selected from a group of steps comprising:
a) data exchange through the server (1);
b) data exchange through other servers; and
c) direct data exchange between turnover controllers.

85. The method of claim 14, wherein the step of servicing comprises at least one step selected from a group of steps comprising:
a) entering into the turnover controller (2) records about service, comprising: type of service, date and time of the beginning and end of service;
b) deregistering removed parts of the turnover controller (2) on the server (1); and
c) registering new parts of the turnover controller (2) on the server (1).

86. At least one processor readable storage medium for storing a computer program of instructions configured to be readable by at least one processor for instructing the at least one processor to execute a computer process for performing the method as recited in claim 13.
